(19) United States
(12) Patent Application Publication
(10) Pub. No.: US 2019/0171753 A1
(43) Pub. Date: Jun. 6, 2019

(54) DIVERSIFICATION OF ITEMS FOR REPRESENTATION TO USER

(71) Applicant: Google Inc., Mountain View, CA (US)

(72) Inventors: Junbin TENG, Cupertino, CA (US); Boris Mazniker, San Francisco, CA (US)

(73) Assignee: Google Inc., Mountain View, CA (US)

(21) Appl. No.: 14/040,460

(22) Filed: Sep. 27, 2013

Related U.S. Application Data
(60) Provisional application No. 61/707,861, filed on Sep. 28, 2012.
(60) Provisional application No. 61/707,802, filed on Sep. 28, 2012.
(60) Provisional application No. 61/707,864, filed on Sep. 28, 2012.

(51) Int. Cl. G06F 17/30

(52) U.S. Cl. CPC G06F 17/30598

(57) ABSTRACT

A method includes identifying a plurality of items, each having a score and being sorted within a list, identifying one or more variation features, diversifying the list of the plurality of items by processing each of the plurality of items in order of the sorting, the processing for each of the plurality of items including selecting the item as a candidate item, determining one or more demotion criteria with respect to the candidate item, determining if one or more items of the plurality of items meet the demotion criteria with respect to the selected item, modifying the score for at least one of the plurality of items based on a demotion factor, rearranging the list according to the score of each of the plurality of items in response to the modifying and providing the list of the plurality of items for display to the user.

### CROSS-REFERENCE TO RELATED APPLICATION

The present application claims the benefit of U.S. Provisional Patent Application Ser. No. 61/707,861, entitled “Demotion of Items for Diversification,” filed on Sep. 28, 2012, U.S. Provisional Patent Application Ser. No. 61/707,802, entitled “Organizing Diversified Result Sets Into Chronological Buckets,” filed on Sep. 28, 2012, and U.S. Provisional Patent Application Ser. No. 61/707,864, entitled “Diversifying Results for Information Feeds,” filed on Sep. 28, 2012, which are hereby incorporated by reference in their entirety for all purposes.

### BACKGROUND

Search results are typically selected for presentation according to a combination of recency and relevancy-based criteria. These search results are usually ranked according to recency. Such recency-based ranking may result in presenting items that are too similar on top of the list. For example, a search for items matching a specific search query during the day, with the results sorted according to recency may result in a large number of items from a few major news agencies, since these have a higher organic rank and they produce a higher volume of content, thus having a higher probability of being fresh.

### SUMMARY

The disclosed subject matter relates to a computer-implemented method including identifying a list of plurality of items, each of the plurality of items having a score, wherein the list of plurality of items is sorted. The method may further include identifying one or more variation features. The method may further include diversifying the list of the plurality of items by processing each of the plurality of items in order of the sorting, the processing for each of the plurality of items including selecting the item as a candidate item. The processing further including determining one or more demotion criteria with respect to the candidate item, wherein the demotion criteria include whether the candidate item and an item of the plurality of items have the same feature value with regard to at least one of the one or more variation features. The processing further including determining if one or more items of the plurality of items meet the demotion criteria with respect to the candidate item. The processing further including modifying the score for at least one of the one or more items based on a demotion factor when one or more items of the plurality of items meet the demotion criteria with respect to the candidate item and rearranging the list of the plurality of items according to the score of each of the plurality of items in response to the modifying. The method may further include providing the list of the plurality of items for display to the user.

In some implementations, the list is sorted according to distance-based criteria. In some implementations, the list is sorted according to the score for each of the plurality of items. In some implementations, the demotion criteria further includes whether an item has a score that satisfies a condition as compared to the score of the candidate item.

The processing may further include calculating a threshold score with respect to the candidate item based on the score of the candidate item and the demotion factor. In some implementations, modifying the score for an item includes setting the score of the item to the threshold score.

The demotion criteria may include whether the score of the item satisfies a condition as compared to the threshold score. In some implementations, the demotion factor is defined based on a distance-based location of the candidate item, a current location and a distance interval for diversifying the list, where each of the location of the selected item, the current location and the distance interval are defined in the same distance-based unit of measurement.

The method may further include determining a value corresponding to the distance interval associated with the at least one feature of the one or more features. The score for each of the plurality of items is calculated based on the relevance and importance of the item and further based on a distance-based location assigned to the item, the distance-based location defining the location of the item with respect to one of the plurality of items or a current location at the time of the identification of the plurality of items.

In some implementations, the distance-based criteria is defined by a unit of measurement, and where the distance interval is a value having the same unit of measurement. In some implementations, the distance-based criteria include time. In some implementations, the distance-based criteria include geographic distance.

The method may further include determining an interval number value N associated with the at least one feature, where the modifying the score for at least one of the one or more items includes selecting a number of the one or more items equal to N and for all other items of the one or more items modifying the score of the item.

In some implementations, the demotion factor is determined at least in part based on one or more of the number of other items of the one or more items or the position of each item of the other items of the one or more items within the list.

The method may further include receiving a collection of items, defining a set of buckets, each bucket of the set of buckets representing a different range of distance-based criteria, determining a value of the distance-based criteria for each item of the collection of items and placing each item of the collection of items within one of buckets of the set of buckets, wherein each item is placed in the bucket having a range containing the value of the distance-based criteria of the item.

The method may further include identifying a first set of features corresponding to each of the items of the collection of items, determining, based on the identified first set of features, whether to move an item from its bucket to another bucket of the set of buckets and moving the item to another bucket when it is determined that the item should be moved.

In some implementations, the list of the plurality of items comprises the items within at least a first bucket of the set of buckets.

The disclosed subject matter also relates to a system including one or more processors and a machine-readable medium including instructions stored therein, which when executed by the processors, cause the processors to perform operations including identifying a list of plurality of items being sorted according to one or more criteria, each of the plurality of items having a score. The operations may further include diversifying the list of the plurality of items according to one or more variation features, the diversifying comprising processing the items of the list of plurality of items, the processing including selecting a first unprocessed item of the plurality of items as a candidate item. The processing may further include determining if one or more items of the plurality of items meet one or more demotion criteria with respect to the candidate item, wherein the demotion criteria include whether the candidate item and an item of the plurality of items have the same feature value with regard to at least one of the one or more variation features. The processing may further include determining a demotion factor. The processing may further include modifying the score for at least one of the one or more items based on the demotion factor when one or more items of the plurality of items meet the demotion criteria with respect to the candidate item. The processing may further include rearranging the list of the plurality of items according to the score of each of the plurality of items. The operations may further include providing the list of the plurality of items for display to the user when all items of the plurality of items have been processed.

The disclosed subject matter also relates to a machine-readable medium including instructions stored therein, which when executed by a machine, cause the machine to perform operations including identifying a list of plurality of items being sorted according to one or more criteria, each of the plurality of items having a score. The operations may further include identifying one or more variation features for diversifying the list. The operations may further include diversifying the list of the plurality of items, the diversifying comprising processing each item of the list of the plurality of items by selecting a first unprocessed item of the plurality of items as a candidate item. The processing may further include determining if one or more items of the plurality of items meet one or more demotion criteria with respect to the candidate item, wherein the demotion criteria include whether the candidate item and an item have the same feature value with regard to at least one of the one or more variation features. The processing may further include determining a demotion factor. The processing may further include modifying the score for at least one of the one or more items based on the demotion factor when one or more items of the plurality of items meet the demotion criteria with respect to the candidate item and rearranging the list of the plurality of items according to the score of each of the plurality of items. The operations may further include providing the list of the plurality of items for display to the user.

In some implementations, the disclosed subject matter relates to a computer-implemented method including identifying a plurality of items sorted according to a distance-based criteria, each of the plurality of items having an initial score. The method further including assigning the initial score of the each of the plurality of items as the current score of that item. The method further including selecting a first item of the plurality of items as a candidate post. The method further including calculating a threshold score for the first item. The method further including determining one or more demotion criteria with respect to the first item. The method further including identifying one or more items of the plurality of items meeting the demotion criteria with respect to the first item and selecting a number of the identified one or more items meeting the demotion criteria with respect to the first item and for all other items of the identified one or more items meeting the demotion criteria with respect to the first item not being selected, setting the current score of the item to the threshold score for the first item. Other aspects can be embodied in corresponding systems and apparatus, including computer program products.

These and other aspects can include one or more of the following features. The first item may be the first unprocessed item of the plurality of items, where an item is considered to be processed when a threshold score is calculated for the item. The demotion criteria may include one or more variation features, a current score of the first item and a threshold score. An item meets the one or more demotion criteria if the item at least one feature of the one or more variation features in common with the first item and has a current score that satisfies a relationship with respect to the current score of the first item and the threshold score. The item satisfies the relationship if the item has a current score that is lower to or equal to the current score of the first item and higher than the threshold score for the first item.

The threshold scores may be calculated based on the current score of the selected item and a demotion factor defined based on a location of the selected item, a current location and a distance interval for diversifying the list, where each of the location of the selected item, the current location and the distance interval are defined in the same unit of measurement as the distance-based criteria.

The method may further include determining if all of the plurality of items have been selected as a candidate post, selecting a next item of the plurality of items as the candidate post if all of the plurality of items have not been selected as a candidate post, calculating a threshold score for the next item, determining one or more demotion criteria with respect to the next item, identifying one or more items of the plurality of items meeting the demotion criteria with respect to the next item and selecting a number of the identified one or more items meeting the demotion criteria with respect to the next item and for all other items of the identified one or more items meeting the demotion criteria with respect to the next item not being selected, setting the current score of the item to the threshold score for the next item. The demotion factor may define an immediacy value of an item if the item was published an interval away from its actual publication location, to the immediacy value of the item, thus delaying item by the interval.

The at least one feature of the one or more features may be associated with a value corresponding to the distance interval, and where the determining the value is based on the value associated with the at least one feature. The distance-based criteria may be defined by a unit of measurement, and where the distance interval is a value having the same unit of measurement. The unit of measurement may include time. The he unit of measurement may include geographic distance.

The initial score for each of the plurality of items may be calculated based on the relevance and importance of the item and further based on a distance-based value assigned to the item, the distance-based location defining the location of the item with respect to one of the plurality of items or a current location at the time of the identification of the plurality of items. The plurality of items may be ranked based on their initial score.

The method may further include identifying a variation feature set for diversifying the list of search results, the variation feature set including the one or more variation features. The method may further include determining a value corresponding to the number of items, the number of items defining the desired number of items within each distance interval which share at least one feature of the one or more features.

The at least one feature of the one or more features may be associated with a value corresponding to the number of items desired for that feature, and where the determining the value is based on the value associated with the at least one feature.

The method may further include determining that all of the plurality of items have been selected as a candidate post and sorting the plurality of items based on the current score of the one or more items when it is determined that all items of the plurality of items have been selected as a candidate post. The method may further include determining a value corresponding to the distance interval, where the distance interval defines an interval defined in terms of the distance-based criteria, for diversifying the list.

The disclosed subject matter also relates to a system including one or more processors and a machine-readable medium including instructions stored therein, which when executed by the processors, cause the processors to perform operations including identifying a plurality of items sorted according to a distance-based criteria, each of the plurality of items having an initial score. The operations further including assigning the initial score of the each of the plurality of items as the current score of that item. The operations further including for each item of the plurality of items selecting the item of the plurality of items as the candidate item, calculating a threshold score for the candidate item, identifying one or more items of the plurality of items having at least one feature of one or more variation features in common with the selected item and having a current score that satisfies one or more criteria, and selecting a number of the one or more items and for all other items of the one or more items not being selected, setting the current score of the item to the threshold score. The operations further including sorting the list of items based on the current score of the one or more items. Other aspects can be embodied in corresponding systems and apparatus, including computer program products.

These and other aspects can include one or more of the following features. The threshold scores may be calculated based on the current score of the selected item and a demotion factor. The demotion factor is may be defined based on a location of the selected item, a current location and a distance interval for diversifying the list, where each of the location of the selected item, the current location and the distance interval are defined in the same unit of measurement as the distance-based criteria. A current score of the selected item satisfies the one or more criteria when the current score of the item satisfies a relationship with respect to the current score of the selected item and the threshold score.

The operations may further include selecting one or more items of the plurality of the plurality of items based on the sorting and providing the selected one or more items for display to a user, where the items are displayed to the user according to the sorting.

The disclosed subject matter also relates to a machine-readable medium including instructions stored therein, which when executed by a machine, cause the machine to perform operations including identifying a plurality of items, each of the plurality of items having a current score. The operations further including selecting a first item of the plurality of items as a candidate post. The operations further including calculating a threshold score for the first item. The operations further including determining one or more demotion criteria with respect to the first item. The operations further including identifying one or more items of the plurality of items meeting the demotion criteria with respect to the first item and selecting a number of the identified one or more items meeting the demotion criteria with respect to the first item and for all other items of the identified one or more items meeting the demotion criteria with respect to the first item not being selected, setting the current score of the item to the threshold score for the first item. Other aspects can be embodied in corresponding systems and apparatus, including computer program products.

These and other aspects can include one or more of the following features. Identifying the plurality of items may include identifying the plurality of items sorted according to a distance-based criteria, each of the plurality of items having an initial score and assigning the initial score of the each of the plurality of items as the current score of that item.

In some implementations, the disclosed subject matter relates to a computer-implemented method including identifying a list of items, the list of items including a plurality of items sorted according to a distance-based criteria, each of the plurality of items having an initial score. The method further including assigning the initial score of the each of the plurality of items as the current score of that item. The method further including selecting a first item of the plurality of items as the selected item. The method further including calculating a threshold score, the threshold scores being calculated based on the current score of the selected item and a demotion factor defined based on a location of the selected item, a current location and a distance interval for diversifying the list, where each of the location of the selected item, the current location and the distance interval are defined in the same unit of measurement as the distance-based criteria. The method further including identifying one or more items of the plurality of items having at least one feature of one or more variation features in common with the selected item, the one or more items each having a current score that satisfies a relationship with respect to the current score of the selected item and the threshold score and selecting a number of the one or more items and for all other items of the one or more items not being selected, setting the current score of the item to the threshold score. Other aspects can be embodied in corresponding systems and apparatus, including computer program products.

These and other aspects can include one or more of the following features. The selected item may be the first item within the plurality of items that is unprocessed, where an item is considered to be processed when a threshold score is calculated for the item.

The method may further include determining whether all items within the list of items have been selected as the selected item and sorting the list of items based on the current score of the one or more items when it is determined that all items within the list of items have been selected as the selected item. The method may further include selecting one or more items of the plurality of the plurality of items based on the sorting and providing the selected one or more items for display to a user, where the items are displayed to the user according to the sorting. The method may further include selecting the next item of the one or more items as the selected item when it is determined that all items within the list of items have not been selected as the selected item.

The relationship may include having a current score that are lower to or equal to the current score of the selected item and higher than the threshold score.

The method may further include determining a value corresponding to the number of items, the number of items defining the desired number of items within each distance interval which share at least one feature of the one or more features.

The at least one feature of the one or more features may be associated with a value corresponding to the number of items desired for that feature, and where the determining the value is based on the value associated with the at least one feature.

The method may further include determining a value corresponding to the distance interval, where the distance interval defines an interval defined in terms of the distance-based criteria, for diversifying the list. The at least one feature of the one or more features may be associated with a value corresponding to the distance interval, and where the determining the value is based on the value associated with the at least one feature. The distance-based criteria may be defined by a unit of measurement, and where the distance interval is a value having the same unit of measurement.

The unit of measurement may include time. The unit of measurement may include geographic distance. The initial score for each of the plurality of items may be calculated based on the relevance and importance of the item and further based on a distance-based value assigned to the item, the distance-based location defining the location of the item with respect to one of the plurality of items or a current location at the time of the identification of the plurality of items.

The plurality of items may be ranked based on their initial score. The demotion factor may define an immediacy value of an item if the item was published an interval away from its actual publication location, to the immediacy value of the item, thus delaying item by the interval.

The disclosed subject matter also relates to a system including one or more processors and a machine-readable medium including instructions stored therein, which when executed by the processors, cause the processors to perform operations including identifying a list of items, the list of items including a plurality of items sorted according to a distance-based criteria, each of the plurality of items having an initial score. The operations further including assigning the initial score of the each of the plurality of items as the current score of that item. The operations further including for each item of the plurality of items selecting the of the plurality of items, calculating a threshold score, the threshold scores being calculated based on the current score of the selected item and a demotion factor defined based on a location of the selected item, a current location and a distance interval for diversifying the list, where each of the location of the selected item, the current location and the distance interval are defined in the same unit of measurement as the distance-based criteria, identifying one or more items of the plurality of items having at least one feature of one or more variation features in common with the selected item, the one or more items each having a current score that satisfies a relationship with respect to the current score of the selected item and the threshold score and selecting a number of the one or more items and for all other items of the one or more items not being selected, setting the current score of the item to the threshold score. The operations further including sorting the list of items based on the current score of the one or more items. Other aspects can be embodied in corresponding systems and apparatus, including computer program products.

These and other aspects can include one or more of the following features. The operations may further include selecting one or more items of the plurality of the plurality of items based on the sorting and providing the selected one or more items for display to a user, where the items are displayed to the user according to the sorting.

The disclosed subject matter also relates to a machine-readable medium including instructions stored therein, which when executed by a machine, cause the machine to perform operations including identifying a list of items, the list of items including a plurality of items sorted according to a distance-based criteria, each of the plurality of items having an initial score. The operations further including assigning the initial score of the each of the plurality of items as the current score of that item. The operations further including for each item of the plurality of items selecting the of the plurality of items, calculating a threshold score, the threshold scores being calculated based on the current score of the selected item and a demotion factor defined based on a location of the selected item, a current location and a distance interval for diversifying the list, where each of the location of the selected item, the current location and the distance interval are defined in the same unit of measurement as the distance-based criteria, identifying one or more items of the plurality of items having at least one feature of one or more variation features in common with the selected item, the one or more items each having a current score that satisfies a relationship with respect to the current score of the selected item and the threshold score and selecting a number of the one or more items and for all other items of the one or more items not being selected, setting the current score of the item to the threshold score. The operations further including sorting the list of items based on the current score of the one or more items and providing the selected one or more items for display to a user, where the items are displayed to the user according to the sorting. Other aspects can be embodied in corresponding systems and apparatus, including computer program products.

These and other aspects described throughout the specification facilitate providing the user with items that are ranked loosely according to distance-based criteria while providing a diversified listing of items, thus improving user experience and engagement with respect to items provided for display to the user.

In one innovative aspect, the disclosed subject matter can be embodied in a method. The method including receiving documents to be provided for display in a web-based information feed, each document including a time stamp. The method may further include defining a set of buckets, each bucket within the set of buckets representing a different period in time. The method may further include placing the documents into the set of buckets, such that a time stamp of each of the documents corresponds to the time period of a bucket into which the document is placed and providing the documents for display in an order based on the bucket into which each document is placed.

These and other embodiments can include one or more of the following features. The method can further include identifying a first set of features corresponding to each of the documents. The method may further include determining, based on the identified first set of features, whether or not to move a document from a first bucket to a second bucket of the set of buckets and moving the document from the first bucket to the second bucket based on the determination. The set of features may include at least one of a number of users the document is shared with, whether the document was shared publicly or to a specified set of users, or a level of the relationship between an author of the document and an owner of the feed. The second bucket may represent a later period in time than the first bucket.

The documents in each bucket of the set of buckets may be diversified based on a second set of features, where the second set of features includes at least one of an author of the document, a social group of a social networking application to which the author of the document belongs, a media content type included in the document, or an audience to which the document is directed. The period of time represented by each bucket of the set of buckets may be of a same duration or of a different duration. The duration of the bucket representing the most recent period of time may be equal to the duration since a last visit of the web-based information feed. At least two documents may be placed into at least one bucket of the set of buckets.

In another innovative aspect, the disclosed subject matter can be embodied in a machine-readable medium. The machine-readable medium may include instructions stored therein, which when executed by a system, cause the system to perform operations including receiving documents to be provided for display in a web-based information feed, each document including a time stamp. The operations may further include defining a set of buckets, each bucket within the set of buckets representing a different period in time. The operations may further include placing the documents into the set of buckets, such that a time stamp of each of the documents corresponds to the time period of a bucket of the set of buckets into which the document is placed. The operations may further include identifying a set of features corresponding to the documents. The operations may further include determining, for each document based on the identified set of features, whether or not to adjust a placement of a document into a bucket. The operations may further include adjusting the placement of the documents based on the determinations and providing, after the adjusting of the placement of each of the documents, the documents for display in an order based on the bucket into which each document is placed.

These and other embodiments can include one or more of the following features. The set of features may include at least one of a number of users the document is shared with, whether the document was shared publicly or to a specified set of users, or a level of the relationship between an author of the document and an owner of the feed. The instructions for adjusting the placement of each of the documents based on the determination may include instructions for moving, based on the determination, each of the documents from a bucket representing an earlier period in time to a bucket representing a later period in time. The machine-readable medium may further include instructions for applying a diversification algorithm to the documents in each of the buckets before the documents are provided for display. The set of buckets into which the documents are placed may be sorted in chronological order prior to the documents being provided for display. The period of time represented by each bucket of the set of buckets may be determined by a pattern in which the web-based information feed is accessed by a user. At least two documents may be placed into at least one bucket of the set of buckets.

In another innovative aspect, the disclosed subject matter can be embodied in a system. The system including one or more processors, and a machine-readable medium including instructions stored therein, which when executed by the processors, cause the processors to perform operations including receiving documents to be provided for display in a web-based information feed, each document including a time stamp. The operations may further include defining a set of buckets, each bucket within the set of buckets representing a different period in time. The operations may further include placing the documents into the set of buckets, such that a time stamp of each of the documents placed corresponds to the time period of a bucket of the set of buckets into which the document is placed. The operations may further include applying a diversification algorithm to documents in each of the buckets and providing the documents for display in an order based on a chronology of the buckets into which the documents are placed.

These and other embodiments can include one or more of the following features. The machine-readable medium of the system may further include instructions for identifying a set of features corresponding to the documents, determining, for each document based on the identified set of features, whether or not to adjust the placement of the document into a bucket, and adjusting the placement of each of the documents based on the determination. The instructions for adjusting the placement of each of the documents based on the determination may include instructions for moving, based on the determination, each of the documents from a bucket representing an earlier period in time to a bucket representing a later period in time.

In another innovative aspect, the disclosed subject matter can be embodied in a method. The method including receiving documents, defining a set of buckets, placing the documents into the set of buckets, and providing the documents for display in an order based on the bucket into which each document is placed.

These and other embodiments can include one or more of the following features. Each of the documents may be provided for display in a web-based information feed. Each document may also include a time stamp. Each bucket within the set of buckets may represent a different period in time. The documents may be placed into the set of buckets, such that a time stamp of each of the documents corresponds to the time period of a bucket of the set of buckets into which the document is placed.

In another innovative aspect, the disclosed subject matter can be embodied in a machine-readable medium. The machine-readable medium may include instructions stored therein, which when executed by a system, cause the system to perform operations including receiving documents, defining a set of buckets, placing the documents into the set of buckets, adjusting the placement of the documents, and providing the documents for display in an order based on the bucket into which each document is placed.

These and other embodiments can include one or more of the following features. Each of the documents may be provided for display in a web-based information feed. Each document may also include a time stamp. Each bucket within the set of buckets may represent a different period in time. The documents may be placed into the set of buckets, such that a time stamp of each of the documents corresponds to the time period of a bucket of the set of buckets into which the document is placed. The machine-readable medium may further include instructions for identifying a set of features corresponding to the documents, and determining, for each document based on the identified set of features, whether or not to adjust a placement of a document into a bucket. The placement of the documents is adjusted based on the determination.

In another innovative aspect, the disclosed subject matter can be embodied in a system. The system may include one or more processors, and a machine-readable medium including instructions stored therein, which when executed by the processors, cause the processors to perform operations including receiving documents, defining a set of buckets, placing the documents into the set of buckets, applying a diversification algorithm to documents in each of the buckets, and providing the documents for display in an order based on a chronology of the buckets into which the documents are placed.

These and other embodiments can include one or more of the following features. Each of the documents is provided for display in a web-based information feed. Each document may also include a time stamp. Each bucket within the set of buckets may represent a different period in time. The documents may be placed into the set of buckets, such that a time stamp of each of the documents corresponds to the time period of a bucket of the set of buckets into which the document is placed.

Advantageously, the subject technology improves the user experience when posts provided for web-based application feeds are presented in an order based on the chronological buckets into which the posts are sorted. By displaying the result sets of posts based on the chronological buckets, discontinuity that may result from a general diversification of posts in a feed on a social networking application may be minimized by localizing diversification to the buckets. The buckets are subsequently provided for display in the feed in chronological order. Such presentation of a feed can provide users with a more natural flow of information to read.

In one innovative aspect, the disclosed subject matter can be embodied in a method. The method includes receiving documents to be provided for display, where each of the documents is arranged in a priority queue based on an initial score. The method may further include defining at least one feature and at least one associated feature value for each of the documents; selecting a document based on the initial score of each of the documents. The method may further include determining, for the selected document, a demotion factor based on one or more of the at least one feature or the at least one associated feature value for the selected document; applying, to the initial score of the selected document, the determined demotion factor to generate an intermediate score for the selected document. The method may further include rearranging the priority queue based on the generated intermediate score of the selected document and the initial scores of a remainder of the documents and providing the selected document for display when the selected document is a same document as a first document in the rearranged priority queue.

These and other embodiments can include one or more of the following features. Selecting the document based on the initial score may include selecting a first document in the priority queue. The at least one feature may include at least one of an author of the selected document, a social group of a social networking application to which the author of the selected document belongs, a media content type included in the selected document, or an audience to which the selected document is directed. The at least one associated feature value of the media content type feature may include at least one of images, videos clips, or audio clips.

The method can further include identifying a demotion limit defining a number of items of similar features or feature values that may exist, where the demotion factor is determined when the demotion limit is satisfied. The demotion factor may be adjusted based on an amount of the similar features or feature values by which the demotion limit is exceeded. Additionally, determining the demotion factor based on one or more of the at least one feature or the at least one associated feature value for the selected document may further include identifying one or more of the at least one feature or the at least one feature value in a document previously provided for display that is shared with the selected document; and calculating the demotion factor based on the identified one or more feature or feature value. When the shared one or more feature or feature value includes two or more features or feature values, calculating the demotion factor based on the shared one or more feature or feature value may include selecting one demotion factor of the demotion factors corresponding to the two or more features or feature values. The selected one demotion factor may correspond to a highest demotion factor of the demotion factors. Alternatively, all demotion factors corresponding to the two or more features or feature values may be applied when calculating the demotion factor based on the shared one or more feature or feature value. The method can also include providing the selected document for display when the determined demotion factor for the selected document is determined to be zero.

The disclosed subject matter also relates to a machine-readable medium including instructions stored therein, which when executed by a system, cause the system to perform operations including receiving documents to be provided for display, where each of the documents is arranged in a priority queue based on an initial score. The operations may further include defining at least one feature and at least one associated feature value for each of the documents. The operations may further include identifying features or feature values in one or more documents previously provided for display. The operations may further include determining, for a first document in the priority queue, a demotion factor based on one or more of the at least one feature or the at least one associated feature value for the document and the identified features or feature values in the one or more documents previously provided for display. The operations may further include applying, to the initial score of the first document in the priority queue, the determined demotion factor to generate an intermediate score for the document; rearranging the priority queue based on the generated intermediate score of the document and the initial scores of a remainder of the documents. The operations may further include and providing the first document in the priority queue for display when the first document in the priority queue is a same document as a first document in the rearranged priority queue.

These and other embodiments can include one or more of the following features. The at least one feature may include at least one of an author of the document, a social group of a social networking application to which the author of the document belongs, a media content type included in the document, or an audience to which the document is directed. The at least one associated feature values of the media content type feature may include at least one of images, videos clips, or audio clips. The demotion factor may be determined based on the number of features or feature values which the first document in the priority queue shares with documents previously provided for display. When two or more features or feature values are shared by the first document in the priority queue with documents previously provided for display, calculating the demotion factor based on the shared two or more feature or feature values may include selecting a highest demotion factor of the demotion factors corresponding to the two or more features or feature values. Alternatively, calculating the demotion factor based on the shared at least one feature or feature value may include applying all demotion factors corresponding to the two or more features or feature values. The machine-readable medium can further include instructions for providing the first document in the priority queue for display when the demotion factor for the first document in the priority queue is determined to be zero. The document may be provided for display in a feed of documents in a social networking application.

In another innovative aspect, the disclosed subject matter can be embodied in a system. The system includes one or more processors, and a machine-readable medium including instructions stored therein, which when executed by the processors, cause the processors to perform operations including receiving documents to be provided for display, where each of the documents is arranged in a priority queue based on an initial score. The operations may further include defining at least one feature and at least one associated feature value for each of the documents; selecting a first document in the priority queue. The operations may further include determining, for the selected document, a demotion factor based on one or more of the at least one feature or the at least one associated feature value for the selected document. The operations may further include applying, to the initial score of the selected document, the determined demotion factor to generate an intermediate score for the selected document. The operations may further include rearranging the priority queue based on the generated intermediate score of the selected document and the initial scores of a remainder of the documents and providing the selected document for display when the demotion factor for the selected document is determined to be zero.

These and other embodiments can include one or more of the following features. The at least one feature may include at least one of an author of the selected document, a social group of a social networking application to which the author of the selected document belongs, a media content type included in the selected document, or an audience to which the selected document is directed. The at least one associated feature value of the media content type feature may include at least one of images, videos clips, or audio clips.

In another innovative aspect, the disclosed subject matter can be embodied in a method. The method includes receiving documents. The method may further include defining at least one feature and at least one associated feature value for each of the documents. The operations may further include selecting a document; determining, for the selected document, a demotion factor; applying, to the initial score of the selected document, the determined demotion factor; rearranging the priority queue and providing the selected document for display.

These and other embodiments can include one or more of the following features. The documents are to be provided for display, and each of the documents are arranged in a priority queue based on an initial score. The document may be selected based on the initial score of each of the documents. The demotion factor may be determined based on one or more of the at least one feature or the at least one associated feature value for the selected document. The determined demotion factor may be applied to the initial score of the selected document to generate an intermediate score for the selected document. The priority queue may be rearranged based on the generated intermediate score of the selected document and the initial scores of a remainder of the documents. The selected document may be provided for display when the selected document may be a same document as a first document in the rearranged priority queue.

The disclosed subject matter also relates to a machine-readable medium including instructions stored therein, which when executed by a system, cause the system to perform operations including receiving documents. The operations may further include defining at least one feature and at least one associated feature value for each of the documents. The operations may further include identifying features or feature values in one or more documents previously provided for display. The operations may further include determining, for a first document in the priority queue, a demotion factor; applying, to the initial score of the first document in the priority queue, the determined demotion factor. The operations may further include rearranging the priority queue and providing the first document in the priority queue for display.

These and other embodiments can include one or more of the following features. The documents are provided for display, and each of the documents may be arranged in a priority queue based on an initial score. The demotion factor may be determined based on one or more of the at least one feature or the at least one associated feature value for the document and the identified features or feature values in the one or more documents previously provided for display. The determined demotion factor may be applied to the initial score of the first document in the priority queue to generate an intermediate score for the first document in the priority queue. The priority queue may be rearranged based on the generated intermediate score of the first document in the priority queue and the initial scores of a remainder of the documents. The first document in the priority queue may be provided for display when the selected document may be a same document as a first document in the rearranged priority queue.

In another innovative aspect, the disclosed subject matter can be embodied in a system. The system may include one or more processors, and a machine-readable medium including instructions stored therein, which when executed by the processors, cause the processors to perform operations including receiving documents. The operations may further include defining at least one feature and at least one associated feature value for each of the documents. The operations may further include selecting a document; determining, for the selected document, a demotion factor. The operations may further include applying, to the initial score of the selected document, the determined demotion factor. The operations may further include rearranging the priority queue and providing the selected document for display.

These and other embodiments can include one or more of the following features. The documents are provided for display, and each of the documents may be arranged in a priority queue based on an initial score. The selected document may be a first document in the priority queue. The demotion factor may be determined based on one or more of the at least one feature or the at least one associated feature value for the selected document. The determined demotion factor may be applied to the initial score of the selected document to generate an intermediate score for the selected document. The priority queue may be rearranged based on the generated intermediate score of the selected document and the initial scores of a remainder of the plurality of documents. The selected document may be provided for display when the demotion factor for the selected document may be determined to be zero.

Advantageously, the subject technology improves the user experience by adjusting the order in which documents (e.g., posts) are provided for display on a social networking application feed. Typically, documents are presented in an order based on an initial score. By adjusting the order in which the documents are presented, the user may be provided with a more diversified set of documents in the feed. As a result, a repetitiveness of a particular feature or feature value of the documents may be minimized, thereby enhancing the experience of the user reading the content.

It is understood that other configurations of the subject technology will become readily apparent from the following detailed description, where various configurations of the subject technology are shown and described by way of illustration. As will be realized, the subject technology is capable of other and different configurations and its several details are capable of modification in various other respects, all without departing from the scope of the subject technology. Accordingly, the drawings and detailed description are to be regarded as illustrative in nature and not as restrictive.

### BRIEF DESCRIPTION OF THE DRAWINGS

Certain features of the subject technology are set forth in the appended claims. However, for purpose of explanation, several implementations of the subject technology are set forth in the following figures.

FIG. 1 illustrates an example client-server network environment, which provides for facilitating diversification through demotion of items.

FIG. 2 illustrates an example of a system for diversifying items provided for display to a user in a feed.

FIG. 3 illustrates a flow diagram of an example process for providing items for display in an order based on buckets into which the items are sorted.

FIG. 4 provides a graphical representation of sorting items into buckets.

FIG. 5 illustrates a flow diagram of an example process for providing a user with a diversified list of items.

FIG. 6 illustrates a flow diagram of an example process for diversifying a list of items.

FIG. 7 provides a graphical representation of steps in an example implementation of process of FIG. 6, for diversification of a list of items.

FIG. 8 illustrates a flow diagram of an example process for facilitating diversification of a list of items.

FIG. 9 provides a graphical representation of steps in an example implementation of process of FIG. 8, for diversification of a list of items.

FIG. 10 conceptually illustrates an electronic system with which some implementations of the subject technology are implemented.

### DETAILED DESCRIPTION

The detailed description set forth below is intended as a description of various configurations of the subject technology and is not intended to represent the only configurations in which the subject technology may be practiced. The appended drawings are incorporated herein and constitute a part of the detailed description. The detailed description includes specific details for the purpose of providing a thorough understanding of the subject technology. However, it will be clear and apparent that the subject technology is not limited to the specific details set forth herein and may be practiced without these specific details.

The present disclosure provides a system and method for increasing diversity in results presented in response to a query (e.g., a search query or other request or query based on specified criteria). In one implementation, the ordering of items provided for display in response to a query is diversified while maintaining a distance-based ranking of the items (e.g., recency-based, or geo-graphic location based). The diversification facilitates providing the user with a larger variety of items, thus encouraging user engagement and exposure to a larger number of items from different sources.

The system identifies a list of items (e.g., in response to a query or request). In some implementations, the items within the list are ranked by some distance-based criteria (e.g., recency (time), geographical distance, etc.) or other similar criteria. In one example, the items may comprise posts generated by one or more users of a social networking service (e.g., post owner) and being provided to the users of the social networking service (e.g., contacts of the post owner) for display within the social stream or feed of the users. In one example, the item may comprise an item, audio, video, text, images, digital file, and other various multi-media and/or digital content.

In one example, prior to diversification, and in order to maintain a relatively chronological ordering of the items, the items may first be ordered according to a distance-based criteria (e.g., recency, geographic proximity, etc.). More particularly, in some implementations, items are sorted into the chronological buckets before being diversified. In some implementations, arranging the items into chronological buckets provides a sense of continuity for user of the social networking service.

In one implementation, items are received and placed in a specific time-based bucket. For example, each item is associated with a time (e.g., a time stamp). A set of buckets are defined, where each bucket of the set represents a different time range or period of time. The items are placed into the buckets according to their time stamp, such that a time stamp of the items within a bucket falls within the time period of that bucket. Items are placed within a bucket by comparing the time associated with the item (e.g., as indicated by the time stamp of the item) to the time range of each bucket. Once the items are placed within buckets, the items may be sorted according to one or more criteria, and presented according to the range associated with each bucket. In one example, the items may be resorted (e.g., within a bucket or across buckets), according to other criteria, including for example, a quality or organic score associated with each item. In one or more implementations, buckets may be defined according to various other distance-based criteria (e.g., geographic location) according to same or similar processes as described herein with respect to time-based buckets.

The sorted items may then be provided for diversification and/or display to the users of the social networking service. In one example, items may be diversified across a bucket, such that items attain their distance-based nature, while being presented in a diversified manner to the user. More particularly, in some implementations, the order of items (e.g., items within a single bucket or across multiple buckets) may be adjusted based on certain features of the items and values associated with those features. In some embodiments, each item is associated with an organic score. In some examples, the organic score is calculated based on the relevancy and/or importance of the item (e.g., according to one or more relevancy criteria and other criteria such as popularity, user preferences, etc.). An organic score may for example be calculated based on one or more quality criteria such as affinity, freshness (e.g., recency based on chronological buckets or timestamp), content, popularity, relevancy, user quality score, or other such criteria indicating the quality of the item and/or user authoring the item.

The original list of items may be ranked according to the organic score of each item. The original list may also be ranked based on the immediacy (e.g., recency, geographic proximity, based on the chronological buckets, etc.) of the item. In one example, the item may be assigned an initial score. The initial score may be calculated based on the organic score and/or the immediacy of the item. In one example, the initial score may be a quality score of the item, wherein the quality score is calculated based on one or more criteria of the item, the organic score of the item and/or the immediacy of the item. The term “immediacy” as used herein refers to the relationship of a distance-based feature of an item (e.g., time stamp, geographic location, etc.) to a benchmark (e.g., current time, current location, etc.).

In one example, diversification of an item may be performed by identifying items having same or similar feature(s) and balancing the similarity of those items against the quality and/or immediacy of the items, to provide a feed for display to the user which provides a list of diversified content that is of interest to the user, and is provided in a manner that appears seamless and natural for the user (e.g., taking into consideration immediacy and/or the distance-based criteria).

In one example, different qualities of each of the items are identified. The values of the different qualities of each item are analyzed so that demotion factors may be applied to certain items that share similar qualities with previous items provided and/or selected for display. For example, if a subsequent item is authored by a same user as a previously displayed item, a demotion factor may be applied to the subsequent item, causing the subsequent item to be placed lower on the queue of items to be displayed.

In some implementations, the system determines one or more variation features for diversifying the ranking of the items. The variation features may include various characteristics, properties and/or information associated with the items including for example the author and/or source of the item, the content of the item, the topic of the item or other similar characteristics or properties associated with the item. The system may identify the variation features, for example, based on analyzing features of the items identified in response to a query or request, based on historical information (e.g., associated with the items, with the request or query, with the user associated with the request or query, overall historical information associated with the system, query type, etc.), based on information associated with the query and/or according to a selection (e.g., by the user or the system administrator). In some implementations, at least one variation feature is selected. The list of items may then be diversified according to the value of the variation feature for each item.

In one example, a first item is selected (e.g., the highest ranked item of the list), and a demotion factor is determined for the first item. The demotion factor may be calculated, for example, based the initial score of an item (e.g., a score based on the quality score, organic score and/or immediacy of the item) and/or the value of the one or more variation features of the item. The demotion factor for the first item is applied to the initial score of the item to generate an intermediate score of the first item. In one implementation, the intermediate score of the first item is used to reorder the list (e.g., based on the intermediate score of the first item and scores associated with the one or more other items). The system may select one or more items for display to the user based on the reordering.

In one example, an intermediate score may be generated for each of the one or more items of the list and a predefined number of items may be selected according to the intermediate score for each item. In another example, the intermediate score is calculated for the highest ranked item of the list, and if after the reordering of the items based on the intermediate score of the highest ranked item and a score of the other items of the list, the item is still the highest ranked item, the item is provided for display to the user. In one example, this process is repeated until a predefined number of items (e.g., some or all items) are provided for display, and/or until all items within the list are processed.

In some implementations, the diversification may be based on a desired variation interval (e.g., distance-based interval) and a number of items desired within each variation interval for the one or more variation features. The variation interval defines a range of variation with respect to a specific set of variation features (e.g., one or more variation features). The interval and/or number of items may be default values, predefined values and/or selectable by a user or administrator. The interval and number of items may be constant for one or more of the variation features and/or may be customized for one or more specific features.

In some implementations, where more than one variation feature exists, and the interval and/or number of items are not constant, the interval and/or number of items associated with the demoting variation feature (e.g., the feature that results in an item being demoted) may determine the demotion factor. In some implementations, if there is more than one demoting variation feature (e.g., the item is being demoted according to more than one variation feature) a maximum demotion factor, minimum demotion factor or some other reasonable combination (such as the median, average, or product of the demotion factors) may be used as the demotion factor.

Once the interval and number of items are determined, the system can perform diversification of the results of the query. As described above, each item has an initial score. In one implementation, the current score for all items within the list is set to their initial score. The original list of items may be ranked according to the initial score of each item. The original list may also be ranked based on the immediacy (e.g., recency, geographic proximity, based on the chronological buckets, etc.) of the item.

The system selects a first unprocessed item (e.g., the highest ranked item not yet processed) having at least one feature of the one or more variation features. The selected item is set as the first item within a first group of items (i.e., the first N items within the defined interval sharing at least one of the variation features). Next, the system calculates a threshold score based on the current score of the first item and the selected interval, where the threshold score defines the next level of items (i.e., the next set of items being demoted). The threshold score defines a score for an item by decreasing its initial score by a factor of the interval.

The system moves down the list of items and finds all unprocessed items within the list of items having at least one variation feature in common with the first item, and further having a current score that satisfies a relationship with respect to the current score of the first item and/or the calculated threshold score. For example, the relationship may consist of the current score being smaller than or equal to the current score of the first item and higher than the calculated threshold score (e.g., where the ordering is from the most immediate item to the most distant item). Alternatively, the relationship may consist of the current score being larger than or equal to the current score of the first item and lower than the threshold score.

The first N items of the identified unprocessed items are then passed through. The first N items may be the first N items within the list of items sharing one or more variation features with the first item (e.g., the highest ranked items within the list, items with the highest initial score and/or items with the highest current score). For the remainder of the items meeting the conditions, the system sets the current score to the threshold score. The first item is then considered to be processed. The process continues for all items within the originally sorted list until all items within the list have been processed. Once the process is completed, the system resorts the items within the list according to the current score of the items and provides the resorted list for display to a user.

The diversification processes described herein may also be generalized to process different feature sets, where items only affect each other if they share features from the same feature set. For example, the system may identify two or more feature sets, each containing several feature values, possibly with intersection. Items with the same feature that belong in both sets will then have to be defined to belong to either set (or both). For example, each feature is redefined as being directed associated with its specific feature set (e.g., SetName_Feature). The system may then implement the processes without any other changes, since features from different feature sets are unique.

The final result is that while items are still loosely sorted by the distance-based criteria, items having similar features are placed apart from one another, resulting in higher diversity in the result set.

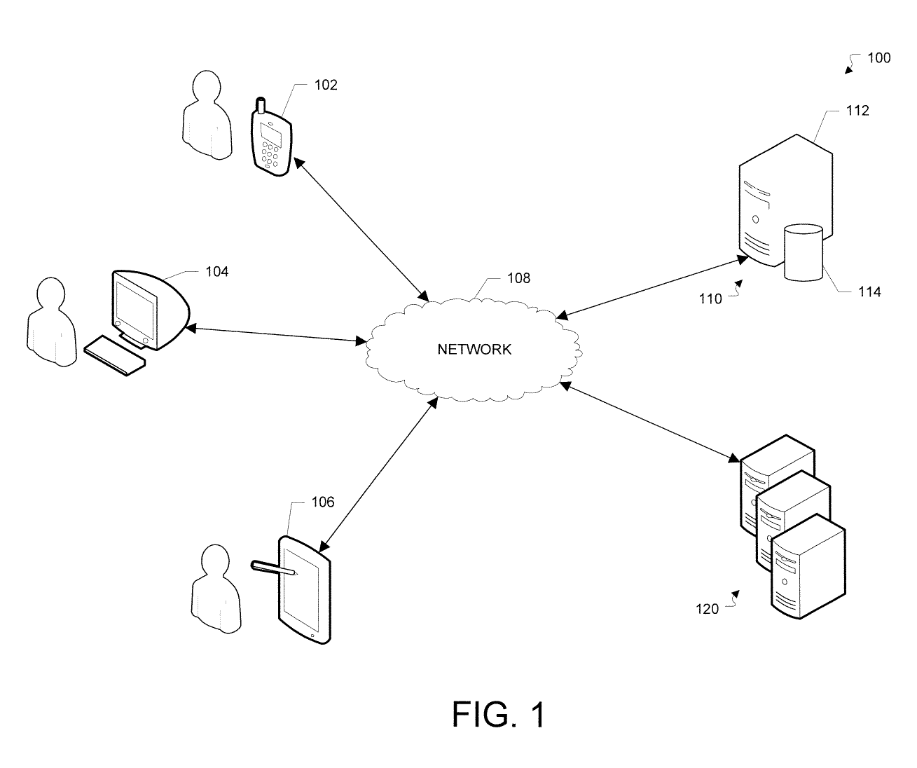

FIG. 1 illustrates an example client-server network environment, which provides for facilitating diversification through demotion of items. A network environment 100 includes a number of electronic devices 102, 104, 106 communicably connected to a server 110 and remote servers 120 by a network 108. Network 108 can be a public communication network (e.g., the Internet, cellular data network, dialup modems over a telephone network) or a private communications network (e.g., private LAN, leased lines). Further, network 108 can include, but is not limited to, any one or more of the following network topologies, including a bus network, a star network, a ring network, a mesh network, a star-bus network, a tree or hierarchical network, and the like.

In some example implementations, electronic devices 102, 104, 106 can be computing devices such as laptop or desktop computers, smartphones, PDAs, portable media players, tablet computers, or other appropriate computing devices. In the example of FIG. 1, electronic device 102 is depicted as a smartphone, electronic device 104 is depicted as a desktop computer and electronic device 106 is depicted as a PDA.

In some implementations, server 110 includes a processing device 112 and a data store 114. Processing device 112 executes computer instructions stored in data store 114, for example, to facilitate generating diversified set of items (e.g., results of a search query) to be provided to users interacting with electronic devices 102, 104, 106. Server 110 may further be in communication with remote servers 120 either through the network 108 or through another network or communication means.

According to some aspects, remote servers 120 can be any system or device having a processor, a memory and communications capability for hosting various data stores storing various items, one or more search engines and/or one or more remote social networking services. Remote servers 120 may be further capable of maintaining tables and indexes of items and associations with users and/or one or more social graphs of users and their contacts.

In some example aspects, server 110 and/or one or more remote servers 120 can be a single computing device such as a computer server. In other implementations, server 110 and/or one or more remote servers 120 can represent more than one computing device working together to perform the actions of a server computer (e.g., cloud computing). Server 110 and/or one or more remote servers 120 may be coupled with various remote databases or storage services. While server 110 and the one or more remote servers 120 are displayed as being remote from one another, it should be understood that the functions performed by these servers may be performed within a single server, or across multiple servers.

Users may interact with the system hosted by server 110, and/or one or more services hosted by remote servers 120, through a client application installed at the electronic devices 102, 104, and 106. Alternatively, the user may interact with the system and the one or more social networking services through a web based browser application at the electronic devices 102, 104, 106. Communication between client devices 102, 104, 106 and the system, and/or one or more social networking services, may be facilitated through a network (e.g., network 108).

Communications between the client devices 102, 104, 106, server 110 and/or one or more remote servers 120 may be facilitated through various communication protocols. In some aspects, client devices 102, 104, 106 may communicate wirelessly through a communication interface (not shown), which may include digital signal processing circuitry where necessary. The communication interface may provide for communications under various modes or protocols, including Global System for Mobile communication (GSM) voice calls, Short Message Service (SMS), Enhanced Messaging Service (EMS), or Multimedia Messaging Service (MMS) messaging, Code Division Multiple Access (CDMA), Time Division Multiple Access (TDMA), Personal Digital Cellular (PDC), Wideband Code Division Multiple Access (WCDMA), CDMA2000, or General Packet Radio System (GPRS), among others. For example, the communication may occur through a radio-frequency transceiver (not shown). In addition, short-range communication may occur, including using a Bluetooth, WiFi, or other such transceiver.

The network 108 can include, for example, any one or more of a personal area network (PAN), a local area network (LAN), a campus area network (CAN), a metropolitan area network (MAN), a wide area network (WAN), a broadband network (BBN), the Internet, and the like. Further, the network 108 can include, but is not limited to, any one or more of the following network topologies, including a bus network, a star network, a ring network, a mesh network, a star-bus network, tree or hierarchical network, and the like.

In example aspects, server 110 may receive a request for items to be provided for display at one or more client devices (e.g., electronic devices 102, 104, 106). Server 110 may retrieve the items from storage (e.g., data store 114). In one example, server 110 may sort the items into chronological buckets. In one or more implementations, server 110 may perform a diversification of the items (e.g., within each of the buckets, across multiple buckets, or across the entire set of items). The items are provided to client devices 108a-108e for display, for example, according to the sorting and/or placement within one or more buckets.

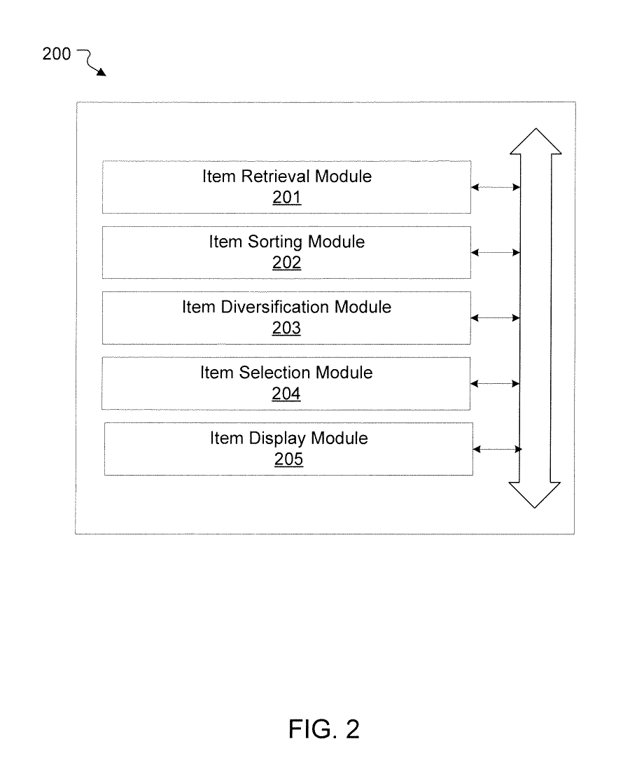

FIG. 2 illustrates an example of a system for diversifying items provided for display to a user in a feed. System 200 includes item retrieval module 201, item sorting module 202, item diversification module 203, item selection module 204 and item display module 205. These modules, which are in communication with one another, process information regarding one or more item (e.g., items for inclusion in a user feed) in order to diversify items for display to the user (e.g., within a feed).

For example, upon receiving an indication of a request to provide the user with a collection of items (e.g., when a user logs into an account of a social networking application), item retrieval module 202 retrieves a set of items (e.g., a list). The items are passed to the item sorting module 202. In one implementation, the item sorting module 202 may order the received items into one or more distance-based buckets. In such implementation, the item sorting module 202 may further sort the items within each bucket, for example, according to a score (e.g., an organic or quality score, and/or based on immediacy). In one example, the item sorting module 202 sorts the items within the list based on quality scores, organic scores and/or immediacy of each of the items. For example, items may be placed in reverse chronological order according to their respective timestamps, or placed in an order from the highest popularity/affinity first to the lowest popularity/affinity last.

The item diversification module 203 diversifies a collection of items (e.g., across a bucket, multiple buckets and/or the list) based on one ore diversification features. In one example, the item diversification module 203 may diversify the items by applying a demotion factor to one or more items. In some implementations, item diversification module 203 may diversify the items according to a desired variation interval. Items are selected after diversification by the item selection module 204 and provided to the item display module 205 to be displayed.

In some aspects, the modules may be implemented in software (e.g., subroutines and code). The software implementation of the modules may operate on server 104. In some aspects, some or all of the modules may be implemented in hardware (e.g., an Application Specific Integrated Circuit (ASIC), a Field Programmable Gate Array (FPGA), a Programmable Logic Device (PLD), a controller, a state machine, gated logic, discrete hardware components, or any other suitable devices) and/or a combination of both. Additional features and functions of these modules according to various aspects of the subject technology are further described in the present disclosure.

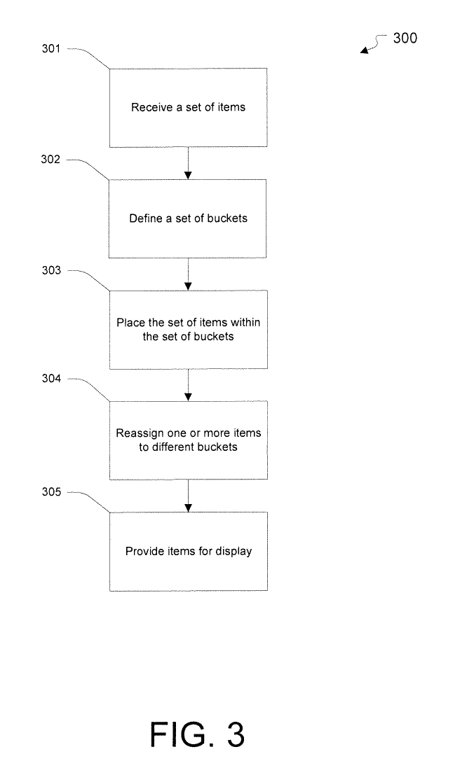

FIG. 3 illustrates a flow diagram of an example process 300 for providing items for display in an order based on buckets into which the items are sorted. For illustration purposes, the process is described herein with respect to an example implementation where items are sorted into time-based buckets according to a timestamp of each item. It should be apparent that the same process may be used to sort items into buckets for various features of the items (e.g., immediacy and/or distance-based features).

In step 301, a set of items are received. The set of items may correspond to items for display to a user (e.g., within a user feed). In one example, the items may correspond to posts at a website or application (e.g., a social networking application). In one example, each item is associated with a time (e.g., a time stamp). In one example, the time refers to the time at which the item was created, posted, shared and/or other action was performed with respect to the item. The item may include a variety of content, including but not limited to text, media files (e.g., image, video, audio etc.) and hyperlinks to other media or applications.

In block 302, a set of buckets is defined, where each bucket within the set of buckets represents a different time range. In some aspects, each bucket of a set of buckets covers a distinct time period exclusive of all other buckets, such that any item may be only placed within a single bucket. Each bucket may be denoted by a start time and an end time, and the range of the bucket may be defined as the end time minus the start time. For example, a bucket of 24 hour time range may start at a current time and cover a time period from the current time to exactly 24 hours earlier.

In some aspects, bucket ranges may be variable. The range of a bucket may be dependent on one or more criteria. For example, the time of the user's last visit, visit frequency or other criteria may be used to assign a time range for one or more buckets. In one example, some buckets may have a variable range while others may have fixed ranges. For example, in one example implementation, the duration of the first bucket of a set of buckets may be varied based on the time of the user's last visit. For example, if the user has not viewed the feed for more than 48 hours, the first (most recent) bucket may be set to span the last 48 hours. Subsequent buckets, however, may be limited to 24 hours.

Applying a limit to the duration of buckets results in a better continuity in the items that may be diversified prior to being used to populate the feed. That is, while the priority of an item in the feed may be changed based on a variation feature other than the distance-based feature of the buckets, the priority of the item, is some examples, is changed across one or more buckets such that diversification is performed while maintaining a sense of continuity in the items being presented for display.

In block 303, the set of items are placed into buckets according to the time range of the bucket and the time associated with each item. For example, a time stamp of each of the items is compared to the time range represented by each bucket, and the item is placed within the bucket having a time range containing the time associated with the item. For example, an item that was created two hours ago will be placed in a bucket that represents a period covering the last 24 hours.

In some examples, in step 304, one or more items may be reassigned from a bucket to another bucket according to one or more other criteria. Such criteria may for example include criteria indicating an importance or quality of the criteria, including for example, item and/or author characteristics of the item. Example characteristics may include a number of users the item is shared with, whether the item was shared publicly or specifically to a set of users, and a level of the relationship between an author of the item and an owner of the feed. When an item is deemed to have promoting characteristics (e.g., a high quality score or a separate importance score), the item may be promoted from its original bucket to a bucket representing items provided for display earlier (e.g., more recent items).

While moving items between buckets may cause potential discontinuity in the order of items provided for display, such promotion of items facilitates displaying more important items earlier.

Once the items have been sorted into their respective buckets, in step 305, the items are provided for display in an order based on the bucket into which each item is placed. The buckets may be presented in reverse chronological order such that a bucket representing a most recent period in time is presented first, and each subsequent bucket that is presented represents an earlier period in time. In some implementations, a diversification process may be run on each of the buckets or across selected buckets to diversify the result set of items within the bucket(s) before the items are provided for display. Since the items are initially sorted into buckets based on their respective time stamps, items residing in the same bucket (or adjacent buckets) are closely related in time and/or other distance-based criteria. Thus, in some implementations, when the items are presented for display in an order based on the buckets, items that may be far apart in time are prevented from appearing close to one another in the final result set, thereby minimizing discontinuity.

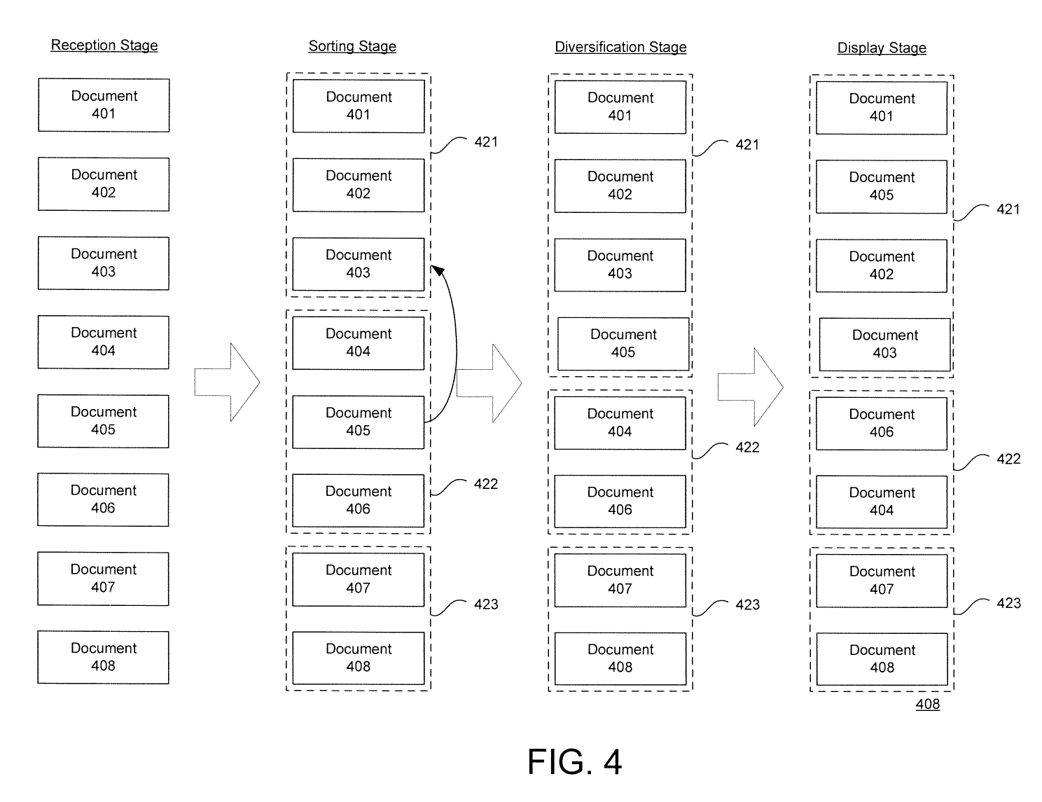

FIG. 4 provides a graphical representation of sorting items into buckets. In the reception stage, Item 401, Item 402, Item 403, Item 404, Item 405, Item 406, Item 407, and Item 408 are received. Each of the Items 401-408, as discussed above, has a corresponding time (e.g., time stamp). In this example, the items are displayed as being arranged in chronological order, with Item 401 having a most recent time stamp, and Item 408 having a least recent time stamp.

In the next stage, the sorting stage, each of the items is placed into one of first bucket 421, second bucket 422, and third bucket 423, such that the time stamp of the item corresponds to the time period of the bucket into which the item is placed. For example, Item 401, Item 402, and Item 403 are placed into first bucket 421 based on the fact that the time stamp of each of the items is within the time period represented by first bucket 421. Similarly, Item 404, Item 405, and Item 406 are placed into second bucket 422; and Item 407 and Item 408 are placed into third bucket 423. As discussed above, each bucket may be denoted by a start time and an end time, and the duration of the bucket is defined as the end time minus the start time.

After the items have been sorted into the buckets, during the sorting stage, one or more items may be reassigned from their original bucket to another bucket. In this example, the features of Item 405 may provide some indicia that Item 405 is of a high level of importance. Thus, Item 405 may be promoted from bucket 422 to a later (in time) bucket, for example, first bucket 421.

In the diversification stage, a diversification algorithm may be run on each of first bucket 421, second bucket 422, and third bucket 423 to diversify the result set of items within each bucket. As discussed above, items residing in a same bucket are closely related in time. Thus, when the items are presented for display in an order based on the bucketing, items that may be far apart in time are prevented from appearing close to one another in the final result set, thereby minimizing discontinuity in an item feed. In performing the diversification, items in each of the buckets may be analyzed based on features that correspond to different characteristics of the item as well as characteristics of the author as they relate to the user. The diversification may be performed independent of the promotion of items.

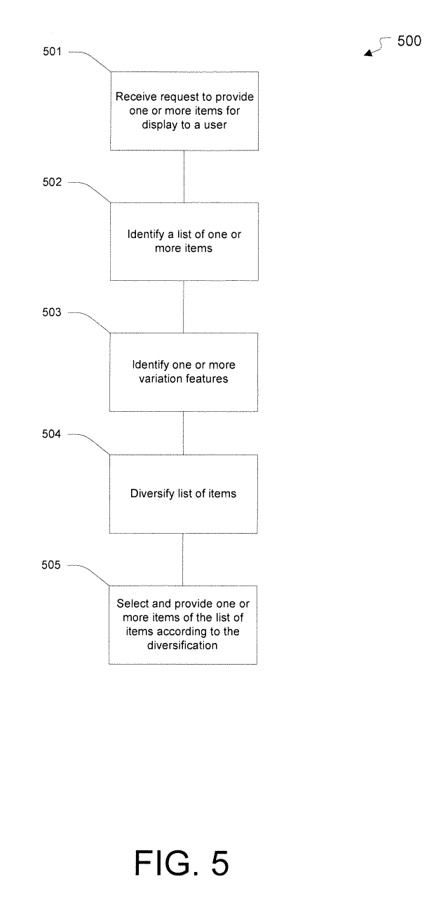

FIG. 5 illustrates a flow diagram of an example process 500 for providing a user with a diversified list of items. In step 501, the system receives a request to provide one or more items for display to a user. The query may be generated by a user, or may be received and/or generated in response to detecting a user logging into a system or requesting to view a webpage, item, application or otherwise taking an action. The query may consist of a search query or other request or query based on specified criteria. In one example, the request may be received in response to a user logging into an application (e.g., social networking application) and/or refreshing or entering a page within the application.

In step 502, the system identifies a list of one or more items in response to the request. In some embodiments, the one or more items are ordered within the list. In one example, the items within the list are ranked by some distance-based criteria (e.g., recency (time), geographical distance, etc.) or other similar criteria. In some implementations, the items may be arranged according to an initial score (e.g., calculated according to an organic score, quality score and/or immediacy of the item). In one example, the one or more items may correspond to social posts that have been chosen for a particular feed on a social networking application. In one example, the list of items consists of one or more items retrieved in response to a query (e.g., a search query or other request or query based on specified criteria). For example, the system may determine a set of criteria (e.g., search or request criteria) and may request a set of items meeting such criteria.

In step 503, the system identifies one or more variation features for diversifying the ranking of the items within the list. The variation features may include various characteristics, properties and/or information associated with the items including for example the author and/or source of the item, the content of the item, the topic of the item or other similar characteristics or properties associated with the item. The system may identify the variation features, for example, based on analyzing features of the items identified in response to the query or request (e.g., the items with the list), based on historical information (e.g., associated with the items, with the request or query, with the user associated with the request or query, overall historical information associated with the system, query type, etc.), based on information associated with the query and/or according to a selection (e.g., by the user or the system administrator). Example variation features may include the author, a social circle on the social networking application to which the author belongs, a breadth of an audience to which the author intends to broadcast the item, an originality of the item (e.g., a repost versus and original post, and human versus machine generated post), a link shared by the item, a type of media (e.g., image, video, audio, etc.) included in the item, and tags associated with the item. Other variation features corresponding to different characteristics of the item as well as characteristics of the author of the item as they relate to the user may also be used.

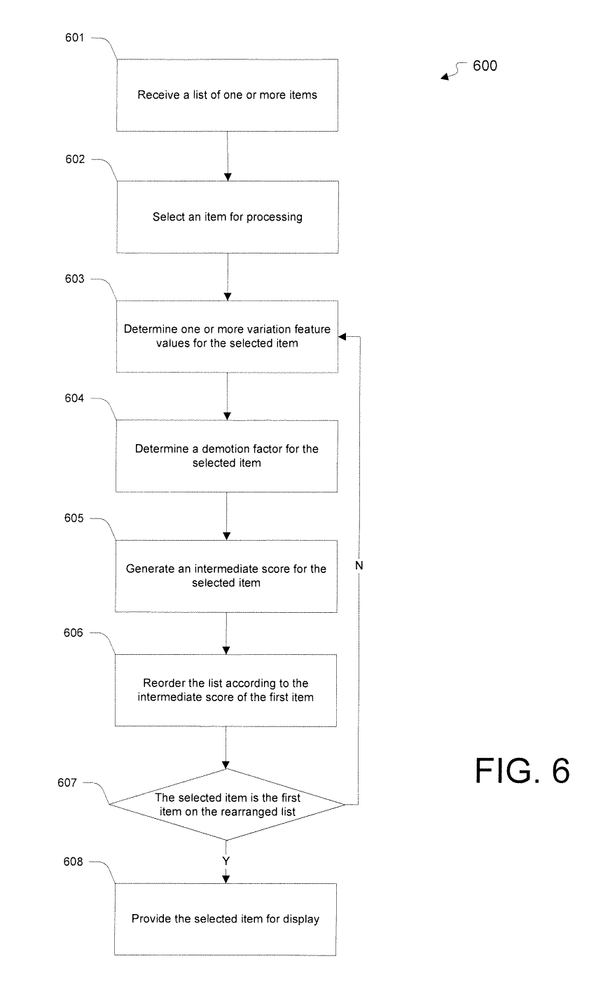

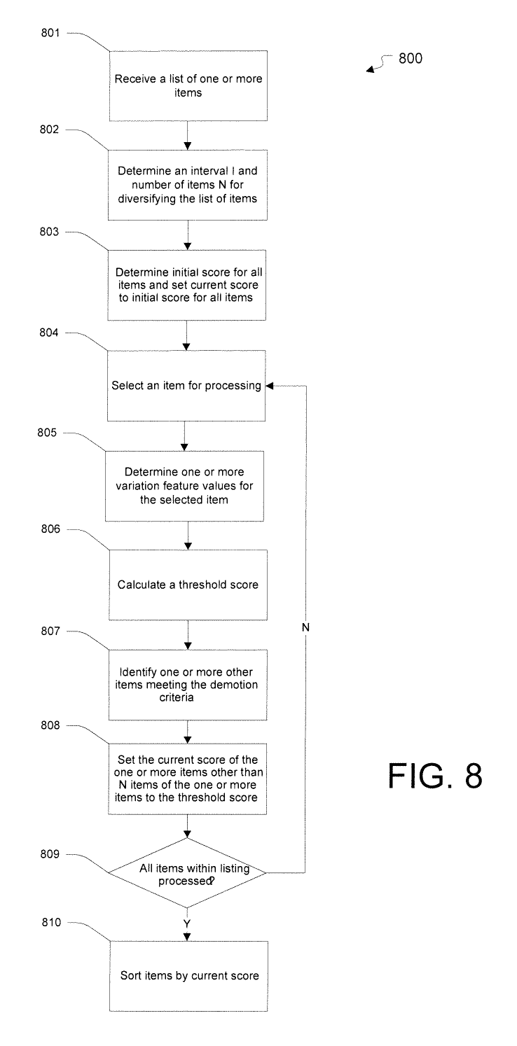

In step 504, the system performs diversification of the list of items. Example processes for diversification of the list of items is described in more details below with respect to FIGS. 6 and 8. In one example, the diversification causes a resorting of the one or more items within the list. In one example, while items are still loosely sorted by the distance-based criteria, items having similar variation feature values are identified and a demotion of the items is performed as necessary, resulting in higher diversity in the result set.

In step 505, the system selects one or more items from the list and provides the items for display to the user according to the ranking generated in response to the diversification. The selected one or more items are then provided for display to the user.

FIG. 6 illustrates a flow diagram of an example process 600 for diversifying a list of items. In step 601, a list of one or more items is received for diversification along with one or more diversification features for diversifying the list. In one example, the items in the list are arranged in order. In one example, the items within the list are ranked by some distance-based criteria (e.g., recency (time), geographical distance, etc.) or other similar criteria. In some implementations, the items may be arranged according to an initial score (e.g., calculated according to an organic score, quality score and/or immediacy of the item). In one example, the one or more items may correspond to social posts that have been chosen for a particular feed on a social networking application.

In step 602, a first item is selected for processing. In some embodiments, the order in which the items are arranged within the list is utilized to determine a next item to process. For example, the highest ranked item on the list may be selected to be processed. In one example, the item is selected based on the immediacy, quality, and/or initial score of each of the items.

In step 603, the variation feature value for one or more variation features for the item is determined. In one example, determining the variation feature value for all items of the list may be performed at once, and/or for each item, the value of a variation feature may be determined at some time before or during the processing of the item. Variation feature values may include examples of variation features. For example, while author's name is a variation feature, the specific name of the author (e.g., John Smith) is the variation feature value. Similarly, media content is considered a variation feature and specific media content types, such as pictures, audio clips, video clips, etc., are considered variation feature values.

In step 604, a demotion factor for the selected item is determined based on the variation feature and/or the associated variation feature value of the item. The demotion factor may be determined based on one or more variation features or one or more variation feature values, or a combination of one or more variation features and one or more variation feature values, as they relate to the variation features and/or variation feature values of previous items that have been provided for display.

For example, a demotion factor may be determined based on the number of items that have already been processed, selected and/or provided for display in a particular feed that are authored by a same user. In this example, a count of the number of items authored by the same user and provided for display may be kept. If the number of items authored by the same user and selected and/or provided for display exceeds a predetermined threshold amount, a demotion factor may be applied to subsequently processed items authored by that particular user that are in the list.

In some implementations, a type of media, such as an image, a video, or an audio, may be the variation feature on which a demotion factor is based. For example, if the number of previously processed items provided for display includes attached images exceeds a predetermined threshold amount, a demotion factor may be applied to subsequently processed items that also include one or more images. Additionally, the demotion factor may vary depending on the number of instances of a repeated variation feature or variation feature value. That is, the first time a variation feature is repeated, a first demotion factor may be applied; however, if the variation feature is repeated a fifth time, then a second demotion factor may be applied, where the second demotion factor causes a more significant demotion of the item than the first demotion factor. The demotion factor of items may similarly be determined based on other variation features and variation feature values, including but not limited to the features described herein.

In some implementations, multiple variation features and/or variation feature values may be used to determine the demotion factor. For example, the item may be subject to a demotion based on multiple instances of a same author and multiple instances of a same media type. In some aspects, a strongest demotion factor is determined to be the demotion factor of the item, and the remainder of the variation features and/or variation feature values is ignored. Under this determination, if the demotion factor from having multiple instances of the same author is greater than the demotion factor from having multiple instances of the same media type, then the demotion factor relating to the author variation feature is determined to be the demotion factor.

Alternatively, the demotion factor may be determined based on a combination of demotion factors from all variation features and/or variation feature values identified. The combination of demotion factors may be determined to be applied consecutively or proportionally. When demotion factors are applied consecutively, the effect of the demotions is compounded. In other words, if having multiple instances of the same author results in a demotion factor of 50% and having multiple instances of the same media type results in a demotion factor of 50% as well, consecutive application of the demotion factors would result in a total demotion factor of 75%. Proportional application of demotions would produce a demotion factor based on even and proportional contribution of demotions relating to each of the variation features and/or variation feature values.

In block 605, the determined demotion factor is applied to the initial score of the selected item to generate an intermediate score for the item. In some implementations, if the item had an initial score of X, and a determine demotion factor of Y is applied, then a resulting intermediate score of X*Y is produced. By applying demotion factors, undesirable effects such as having repetitive themes (e.g., multiple posts from the same user, multiple posts of the same type of media, multiple post of the same hyperlink, etc.) may be minimized in a user's feed.

Once the demotion factor has been applied, in step 606, the list is rearranged based on the generated intermediate score of the selected item and the initial scores of a remainder of the items. In some instances, an item may not be demoted (e.g., no demotion factors may be applied to the item). For example, if the selected item has no predecessor items that have been selected and/or provided for display that share one or more similar values of variation features with the item, then the variation features and variation feature values of the item will not produce any demotion factors. In such instances, the item may be provided for display, for example, in a feed of posts on a social networking application. While the demotion factor serves to reduce the priority of an item, the resulting score of the item may or may not cause a change in the position of the item in the list.

In step 607, the system determines if the first item is still ranked first in the reordered list. If so, the process moves to step 608 and the item is provided for display. However, if the generated intermediate score, as a result of the demotion factor, causes the selected item to no longer be prioritized before the remainder of the items, the process returns to step 204 and selects another item in the queue for processing (e.g., the highest ranked unprocessed item). The process may be repeated until all the items have been processed and/or provided for display.

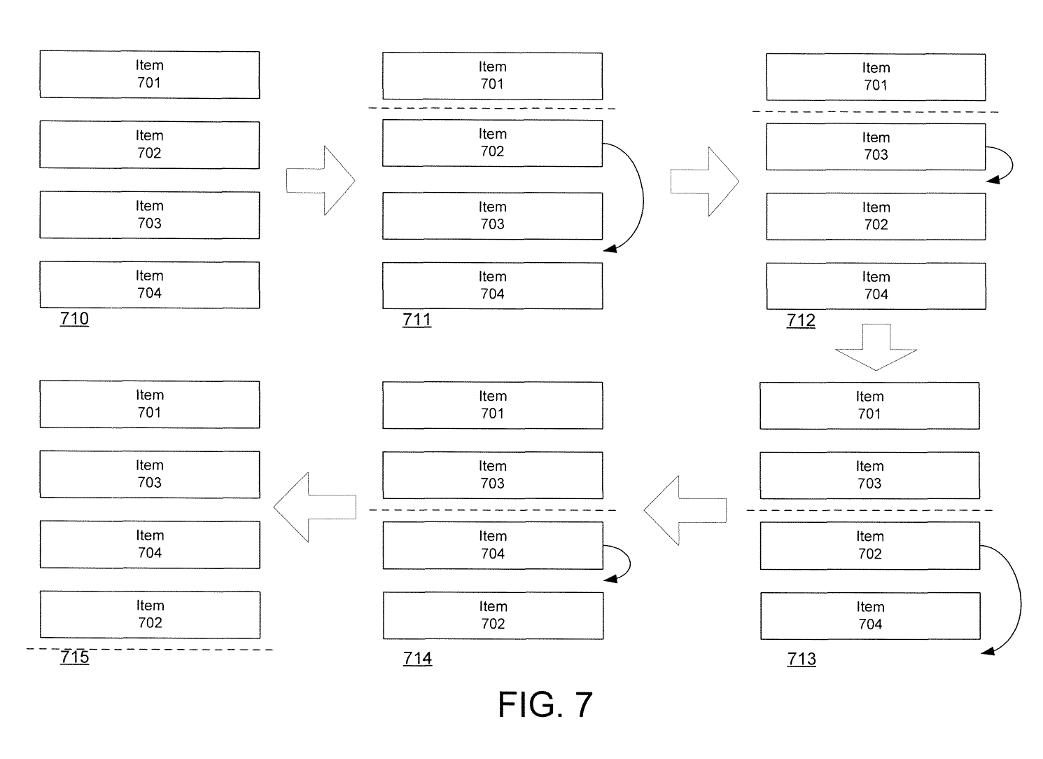

FIG. 7 provides a graphical representation of steps in an example implementation of process 600, described above with respect to FIG. 6, for diversification of a list of items. In step 710, Item 701, Item 702, Item 703, and Item 704 are received and arranged in a list. In one example, the list is arranged according to one or more criteria including a score (e.g., initial score, organic score, quality score) and/or immediacy of the item. At this stage, Item 701 is at the top of the list and Item 704 is at the bottom of the list. In this example, no demotion factor is applied to Item 701 (e.g., since no other items have been processed yet), and thus Item 701 is output for display as shown in step 711.

Once Item 701 has been output, the item at the top of the list will be Item 702. Item 702 is selected for processing in step 711. During step 711, it is determined that Item 702 shares a variation feature with Item 701, and thus needs to be demoted. When Item 702 is processed, a demotion factor may cause the new score of Item 702 to fall below the score of Item 703. Thus, as shown in step 712, the list is updated and Item 702 is placed below Item 703, and the list is arranged in the order of Item 703, Item 702, and Item 704.

In step 713, Item 703 is processed. In this example, Item 703 has no variation features and/or variation feature values in common with Item 701, and thus no demotion factors are applied to item 703. Thus, Item 703 is output for display since it remains the first item in the list. Next, Item 702 is processed again in step 708. Item 702, in this step, also has some variation features in common with Item 703, so the score of Item 702 is now demoted by both Item 701 and Item 703. As a result, the final score of Item 702 is smaller than the score of Item 704 in this example. The score for Item 702 is again updated and Item 702 is placed below item 704 in the list. This time Item 702 is prioritized after Item 704 at the beginning of step 714.

In step 714, Item 704 is processed. While Item 704 may share some variation features with Item 703, and a demotion factor may be applied to Item 704, the updated score may not demote Item 704 below that of Item 702, as shown in this example. Thus, in step 715, the list is still arranged in the order of Item 704 and then Item 702. Item 704 is then output for display. Finally, Item 702 is the only remaining item, and thus cannot be demoted. Item 702 is subsequently output for display to end the process. As a result, the feed of items would present the items in the order of Item 701, Item 703, Item 704, and then Item 702, as shown in step 715.

FIG. 8 illustrates a flow diagram of an example process 800 for facilitating diversification of a list of items. In step 801, a list of one or more items is received for diversification. In one example, one or more diversification features for diversifying the list are identified. In one example, the items in the list are arranged in order. In one example, the items within the list are ranked by some distance-based criteria (e.g., recency (time), geographical distance, etc.) or other similar criteria. For example, the items may be sorted according to an initial score determined based on the item relevancy and importance (e.g., with respect to the query) and/or item immediacy according to a distance-based criteria (e.g., recency, geographic or location proximity). In one example, the one or more items may correspond to social posts that have been chosen for a particular feed on a social networking application.

In step 802, the system determines a desired variation interval “I” (e.g., distance or time interval) and a number of items “N” desired within each time interval for the one or more variation features. The interval and/or number of items may be default values, predefined values and/or selectable by a user or administrator. The interval and number of items may be constant for one or more of the variation features and/or may be customized for one or more specific features.

In one or more example implementations, each variation feature is associated with an interval I and a number of items N. In some implementations, where more than one variation feature exists, and the interval and/or number of items are not constant for the variation features, the interval and/or number of items associated with the demoting variation feature (e.g., the feature that results in an item being demoted) determine the demotion factor, which is defined in terms of the variation interval and/or the number of items. If there is more than one demoting variation feature (e.g., the item is being demoted according to more than one variation feature) a maximum demotion factor, minimum demotion factor or some other reasonable combination (such as the product of the demotion factors) may be used as the demotion factor.

In step 803, an initial score for each item of the list of items is determined and the current score of each item is set to its determined initial score. In some examples, each item has an initial score calculated based on the relevancy and/or importance of the item (e.g., according to one or more relevancy criteria and other criteria such as popularity, user preferences, etc.). The initial score may further be calculated based on the immediacy of the item according to the distance-based criteria (e.g., recency where the distance-based criteria is time, geographic proximity where the distance-based criteria is time, etc.). The initial score may, for example, be defined as:

InitialScore(D)=OrganicScore(D)*Immediacy(current location,D.location)

where D is the item, OrganicScore is a score assigned to the item based on one or more quality criteria defining item quality (e.g., an item quality score calculated based on item characteristics, properties, and other metrics defining the overall quality of the item), and/or the item relevancy and importance in relation to the query, and immediacy indicates the immediacy of the item to the current state or location of the query or request, based on the distance-based criteria (e.g., current time stamp, geographic location, etc., compared to the current time stamp, geographic location, etc.). Immediacy may be defined as:

Immediacy=function of (current location−D.location)

Where immediacy decreases as D moves away from the current location (e.g., in time or geographic location or other distance-based benchmark).

In step 804, a first item is selected for processing. In some embodiments, the order in which the items are arranged within the list is utilized to determine a next item to process. For example, the highest ranked item on the list may be selected to be processed. In one example, the first unprocessed item of the list (e.g., the highest ranked item) is selected.

In step 805, the associated variation feature value for one or more variation features for the selected item is determined. In one example, determining the variation feature value for all items of the list may be performed at once, and/or for each item, the value of a variation feature may be determined at some time before or during the processing of the item. Variation feature values may include examples of variation features. For example, while author's name is a variation feature, the specific name of the author (e.g., John Smith) is the variation feature value.

In step 806, a threshold score is calculated. In one example, the threshold score is calculated based on the current score of the selected item, and/or the determined variation interval I (being defined in the measurement unit defining the distance-based criteria).

In some implementations, the threshold score defines the next level of items (i.e., the next set of items being demoted). The threshold score defines a score for an item by decreasing its ranking (e.g., based on immediacy and/or quality) by a factor of the identified interval “I” (e.g., the score for the first item if it was published an interval away from its actual publication location), referred to generally as the demotion factor. For example, the threshold score may be defined as:

ThresholdScore(D)=CurrentScore(D)*Decay(currentlocation,D.publication_location,I)

Where Decay indicates a ratio of the decay multiplier that D gets, if it was published a time interval away from its actual publication location, to the immediacy multiplier D actually gets (e.g., delaying or advancing D by an interval I). For example Decay may be defined as:

Decay(currentlocation,D.publication_location,I)=Immediacy(currentlocation,D.publication_location+I)/Immediacy(currentlocation,D.publication_location)

Where the list is being ranked from the closest location to the furthest location, or:

Decay(currentlocation,D.publication_location,I)=Immediacy(currentlocation,D.publication_location−I)/Immediacy(currentlocation,D.publication_location)

Where the list is being ranked from the further location to the closest location.

Next, in step 807, the system identifies one or more other items meeting a demotion criteria. The demotion the criteria is defined as an item having at least one variation feature of the identified one or more variation features in common with the identified item of step 804 and/or having a current score that satisfies a relationship with respect to the current score of the item being processed and/or the threshold score. For example, the relationship may consist of the current score being smaller than or equal to the current score of the first item and higher than the threshold score or vice versa. In another example, the criteria may require that the current score is larger than or equal to the current score of the first item and/or higher than the threshold score (e.g., where the order of ranking is reversed, e.g., farthest to closest). Unprocessed items are defined as those items which have not yet been selected in step 803 and processed according to steps 805-808.

Thus, in step 807, the system identifies one or more unprocessed items of the list of items having at least one of one the one or more variation features in common with the first item and having a current score that meets the required relationship with respect to the current score of the item identified in step 804 and/or the threshold score calculated in step 806. The system, for example, finds all unprocessed items within the list of items having at least one variation feature in common with the first item, and further having a current score that satisfies a relationship with respect to the current score of the first item and the threshold score. The first N items of the identified unprocessed items are then passed through. The first N items may be the first N items within the list of item. In one example, the highest ranked items may include those with the highest initial score, or the first N items with the highest current score.

Next, in step 808, for the remainder of the items (e.g., those items other than the N items passed through), the system sets the current score to the threshold score. The first item is then considered to be processed. In step 809, the system determines if all items within the list have been processed, if not, the process returns to step 804 and the next unprocessed item is selected for processing. Thus, the process continues for all items within the originally sorted list of items until, in step 809, it is determined that all items have been processed. Once, in step 809, it is determined that all items have been processed, in step 810, the items of the list of items are sorted according to the current score of the items.

The above processes may be applied to a list of items sorted according to various distance-based criteria, to create a diversified list. In one example, the diversification is performed in a list being sorted according to time. In such example, the system identifies a time interval, T, which defines a desired recency variation time interval, and a number, N, which defines the number of items desired within each time interval T. In one example, the time interval T and number of items N may be default values. In one example, the time interval T and N may be selectable by a user or administrator. The time interval T and N may be constant for all features, or may vary for each unique feature. The feature that results in an item being demoted will then determine the demotion factor. If an item is being demoted according to multiple features, then the system may select the maximum demotion factor, minimum demotion factor or some other reasonable combination (such as product) of all the demotion factors.

The system determines the initial score of each item and sets the current score for all items within the list to their initial score. The initial score may for example be defined as:

InitialScore(D)=OrganicScore(D)*Freshness(now.timestamp,D.timestamp)

Where D is the item, OrganicScore is a score assigned to the item based on one or more of the item quality (e.g., an item quality score), and/or the item relevancy and importance in relation to the query, and freshness indicates the recency of the item. Freshness may be defined as:

Freshness=function of (now.timestamp−D.timestamp)

Where freshness decreases as D gets older.

The system selects a first unprocessed item (e.g., the highest ranked item not yet processed) having at least one feature of the one or more variation features. The selected item is set as the first item within the first group of items (i.e., the first N items within the time interval T). Next, the system calculates a threshold score based on the current score of the first item and time interval T, where the threshold score defines the next level of items (i.e., the next set of items being demoted). The threshold score defines a score for an item by decreasing its freshness by a factor of time interval T (e.g., the score for the first item if it was published a time interval T earlier (the first item is a time interval T older)). For example, the threshold score may be defined as:

ThresholdScore(D)=CurrentScore(D)*FreshnessDecay(now.timestamp,D.timestamp,T)

Where freshness decay indicates a ratio of the freshness multiplier that D gets, if it was published a time interval T earlier (D is T older), to the freshness multiplier D actually gets, thus delaying D by a time interval T. For example freshness decay may be defined as:

FreshnessDecay(now.timestamp,D.timestamp,T)=Freshness(now.timestamp,D.timestamp−T)/Freshness(now.timestamp,D.timestamp)

The system next moves down the list of items and finds all unprocessed items within the list of items having at least one variation feature in common with the first item, and further having a current score that is smaller than or equal to the current score of the first item and higher than the threshold score. The first N items of the identified unprocessed items are then passed through. The first N items may be the first N items within the list of items, i.e., those with the highest initial score, or the first N items with the highest current score. For the remainder of the items, the system sets the current score to the threshold score. The first item is then considered to be processed. The process continues for all items within the originally sorted list until all items within the list are processed. Once the process is completed, the system resorts the items within the list according to the current score of the items and provides the resorted list for display to a user.

The final result is that while items are still loosely sorted by time, if there are more than N items which were published within any time period T, which share one or more variation features, items starting from the N+1 th, will be scored lower, resulting in higher diversity in the result set.

The above example is used where the ranking based on time is performed based on the newest items being ranked on top, however the same method may be used for a list of items being ranked from oldest to newest. In such instance, the definition of freshness decay is adjusted to generate a threshold score that indicates a score for the first item if the first item was published a time interval later (first item is a time interval T newer). For example, the freshness decay may be defined as:

FreshnessDecay(now.timestamp,D.timestamp,T)=Freshness(now.timestamp,D.timestamp+T)/Freshness(now.timestamp,D.timestamp)

Where freshness decay defines the ratio of the freshness multiplier that D gets, if it was published T seconds later, to the freshness multiplier D actually gets.

While the above algorithm is defined for being used for ranking items based on recency, the same method may be used for various other distance-based ranking criteria (e.g., geographical distance). In such example, the freshness function is replaced by some other indicator of the ranking of the items within the list and defined based on a current state (e.g., time or location) and the original state of the item (e.g., time item was published, or location of item).

For example, where the distance-based ranking criteria is geographic distance, T may be defined to be some distance interval, and the initial score of each item may be defined as:

InitialScore(D)=OrganicScore(D)*GeoScore(user.location,D.publication_location)

A threshold score may be defined as the score of the first item, if it was published T distance away from where it was actually published.

ThresholdScore(D)=CurrentScore(D)*GeoDecay(user.location,D.publication_location,T)

where GeoDecay(user.location, D.publication_location, T)=GeoScore (user.location, D.publication_location+T)/GeoScore(user.location, D.publication_location)

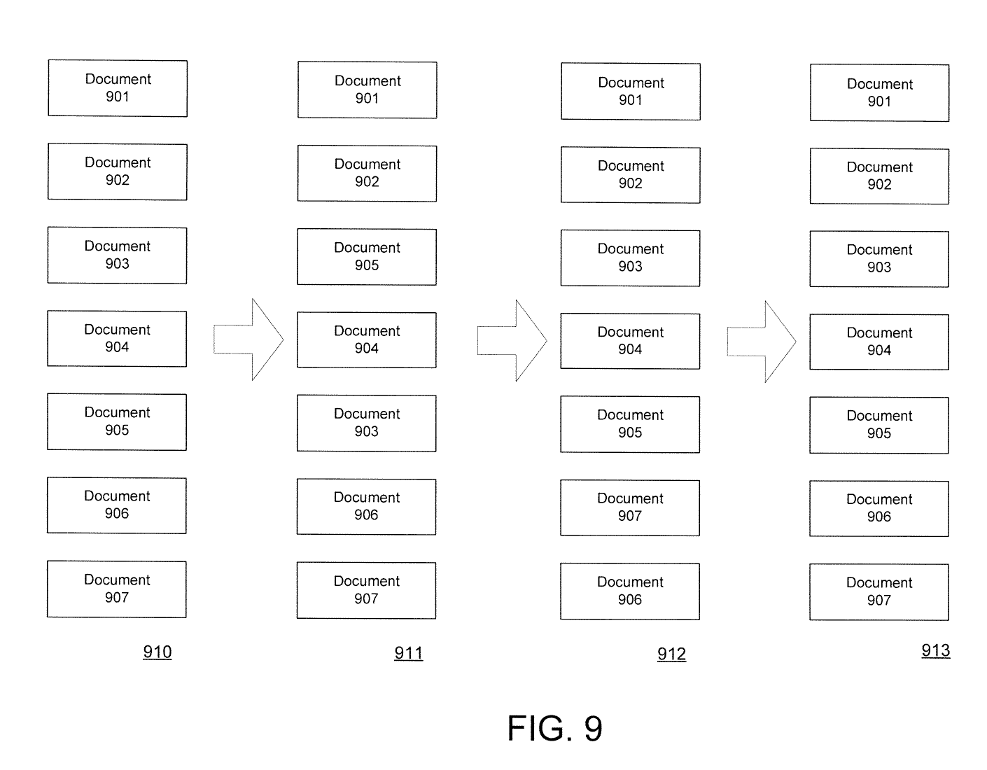

FIG. 9 provides a graphical representation of steps in an example implementation of process 800, described above with respect to FIG. 8, for diversification of a list of items. In step 910, Item 901, Item 902, Item 903, Item 904, Item 905, Item 906, and Item 907 are received and arranged in a list. In one example, the list is arranged according to one or more criteria including a score (e.g., initial score, organic score, quality score) and/or immediacy of the item. In this example, the items are arranged according to a distance-based criteria. The current score of all of the items is sent to the initial score. At this stage, Item 901 is at the top of the list and thus selected for processing. A threshold score is calculated for Item 901.

Items 902-907 are analyzed to determine if they meet the demotion criteria with respect to Item 901. That is, it is determined if Items 901-907 share at least one variation feature value with Item 901 and have a current score that is lower than the current score of Item 901 and higher than the calculated threshold score for item 901. In this example, it is determined that items 902 and 903 meet the demotion criteria. A value N is determined which indicates the number of items desired within each interval. Here, it is assumed that N is 2. Thus Item 901 and 902 are passed through. The current score for item 903 is set to the threshold score. The list is then rearranged. The rearranged list is shown in step 911, where the new current score of Item 903 causes it to be placed below Item 904 and 905.

In step 911, the next item in the list, Item 902, is selected for processing. A threshold score is determined and it is determined if any of the items meet the demotion criteria with respect to Item 902. In this example, no items are determined to meet the demotion criteria. Thus, no rearranging of the list is performed and the process is repeated for the next item for processing, which is in this example is now Item 904. It is determined that Items 905, and 906 meet the demotion criteria. Item 905 is passed through and the current score for Item 906 is set to the calculated threshold score for Item 904. The list is then rearranged as shown in step 912, causing Item 906 to move below Item 907 based on the new current score for Item 906. The process is repeated for Items 905, 903, 906 and 907. In this example, no other items meet the demotion criteria, no other rearranging is performed. Once it is determined that all items have been processed, the process ends and the list is passed through, as shown in step 913.

The final result is that while items are still loosely sorted by time, if there are more than N items which were published within any time period T, which share one or more variation features, items starting from the N+1th, will be scored lower, resulting in higher diversity in the result set.

In situations in which the system and processes discussed here collect or make use of personal information about users, the users may be provided with an opportunity to control whether and/or to what extent the programs or features collect and make use of such user information (e.g., information about user social network, contacts, user preferences, historical activity, profile information), or to control whether and/or how to receive content from the content server that may be more relevant to the user. In addition, certain data may be treated in one or more ways before it is stored or used, so that personally identifiable information is removed. For example, a user's identity may be treated so that no personally identifiable information can be determined for the user, or a user's geographic location may be generalized where location information is obtained (such as to a city, ZIP code, or state level), so that a particular location of a user cannot be determined. Thus, the user may have control over how information is collected about the user and used by a content server.

In addition, where information regarding content generated by the user is stored and/or shared with one or more other users, various privacy controls may be employed to facilitate protecting the storing and/or sharing of such content to the extent that the content includes personal data or to the extent that the user has selected to limit the visibility of the data to one or more other users.

Many of the above-described features and applications are implemented as software processes that are specified as a set of instructions recorded on a computer readable storage medium (also referred to as computer readable medium). When these instructions are executed by one or more processing unit(s) (e.g., one or more processors, cores of processors, or other processing units), they cause the processing unit(s) to perform the actions indicated in the instructions. Examples of computer readable media include, but are not limited to, CD-ROMs, flash drives, RAM chips, hard drives, EPROMs, etc. The computer readable media does not include carrier waves and electronic signals passing wirelessly or over wired connections.

In this specification, the term “software” is meant to include firmware residing in read-only memory or applications stored in magnetic storage, which can be read into memory for processing by a processor. Also, in some implementations, multiple software aspects of the subject disclosure can be implemented as sub-parts of a larger program while remaining distinct software aspects of the subject disclosure. In some implementations, multiple software aspects can also be implemented as separate programs. Finally, any combination of separate programs that together implement a software aspect described here is within the scope of the subject disclosure. In some implementations, the software programs, when installed to operate on one or more electronic systems, define one or more specific machine implementations that execute and perform the operations of the software programs.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

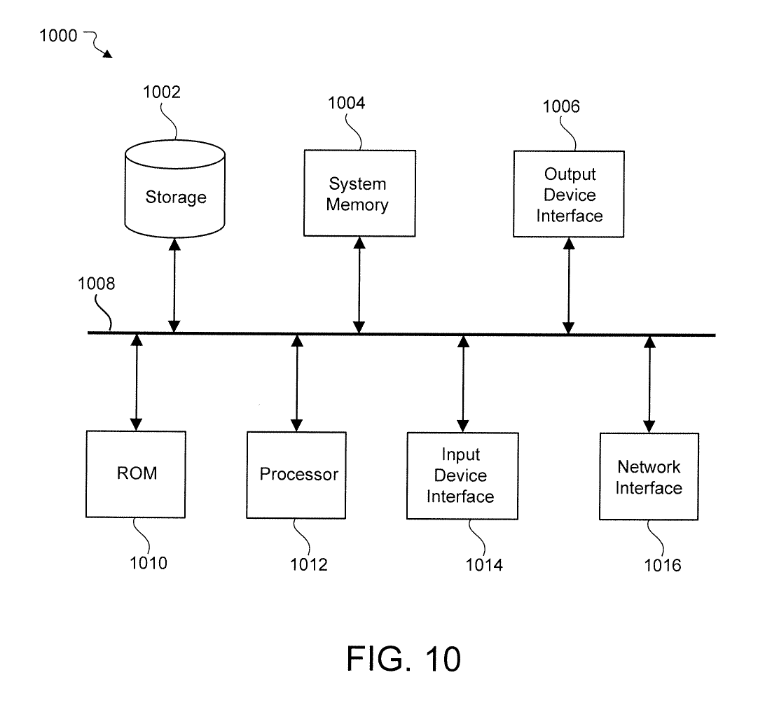

FIG. 10 conceptually illustrates an electronic system with which some implementations of the subject technology are implemented. Electronic system 1000 can be a server, computer, phone, PDA, laptop, tablet computer, television with one or more processors embedded therein or coupled thereto, or any other sort of electronic device. Such an electronic system includes various types of computer readable media and interfaces for various other types of computer readable media. Electronic system 1000 includes a bus 1008, processing unit(s) 412, a system memory 1004, a read-only memory (ROM) 410, a permanent storage device 1002, an input device interface 414, an output device interface 1006, and a network interface 416.

Bus 1008 collectively represents all system, peripheral, and chipset buses that communicatively connect the numerous internal devices of electronic system 1000. For instance, bus 1008 communicatively connects processing unit(s) 412 with ROM 410, system memory 1004, and permanent storage device 1002.

From these various memory units, processing unit(s) 412 retrieves instructions to execute and data to process in order to execute the processes of the subject disclosure. The processing unit(s) can be a single processor or a multi-core processor in different implementations.

ROM 410 stores static data and instructions that are needed by processing unit(s) 412 and other modules of the electronic system. Permanent storage device 1002, on the other hand, is a read-and-write memory device. This device is a non-volatile memory unit that stores instructions and data even when electronic system 1000 is off. Some implementations of the subject disclosure use a mass-storage device (such as a magnetic or optical disk and its corresponding disk drive) as permanent storage device 1002.

Other implementations use a removable storage device (such as a floppy disk, flash drive, and its corresponding disk drive) as permanent storage device 1002. Like permanent storage device 1002, system memory 1004 is a read-and-write memory device. However, unlike storage device 1002, system memory 1004 is a volatile read-and-write memory, such a random access memory. System memory 1004 stores some of the instructions and data that the processor needs at runtime. In some implementations, the processes of the subject disclosure are stored in system memory 1004, permanent storage device 1002, and/or ROM 410. For example, the various memory units include instructions for facilitating diversification of items provided to a user in response to a query. From these various memory units, processing unit(s) 412 retrieves instructions to execute and data to process in order to execute the processes of some implementations.

Bus 1008 also connects to input and output device interfaces 414 and 1006. Input device interface 414 enables the user to communicate information and select commands to the electronic system. Input devices used with input device interface 414 include, for example, alphanumeric keyboards and pointing devices (also called “cursor control devices”). Output device interfaces 1006 enables, for example, the display of images generated by the electronic system 1000. Output devices used with output device interface 1006 include, for example, printers and display devices, such as cathode ray tubes (CRT) or liquid crystal displays (LCD). Some implementations include devices such as a touchscreen that functions as both input and output devices.

Finally, as shown in FIG. 4, bus 1008 also couples electronic system 1000 to a network (not shown) through a network interface 416. In this manner, the computer can be a part of a network of computers (such as a local area network (“LAN”), a wide area network (“WAN”), or an Intranet, or a network of networks, such as the Internet. Any or all components of electronic system 1000 can be used in conjunction with the subject disclosure.

These functions described above can be implemented in digital electronic circuitry, in computer software, firmware or hardware. The techniques can be implemented using one or more computer program products. Programmable processors and computers can be included in or packaged as mobile devices. The processes and logic flows can be performed by one or more programmable processors and by one or more programmable logic circuitry. General and special purpose computing devices and storage devices can be interconnected through communication networks.

Some implementations include electronic components, such as microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, read-only and recordable Blu-Ray® discs, ultra density optical discs, any other optical or magnetic media, and floppy disks. The computer-readable media can store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

While the above discussion primarily refers to microprocessor or multi-core processors that execute software, some implementations are performed by one or more integrated circuits, such as application specific integrated circuits (ASICs) or field programmable gate arrays (FPGAs). In some implementations, such integrated circuits execute instructions that are stored on the circuit itself.

As used in this specification and any claims of this application, the terms “computer”, “server”, “processor”, and “memory” all refer to electronic or other technological devices. These terms exclude people or groups of people. For the purposes of the specification, the terms display or displaying means displaying on an electronic device. As used in this specification and any claims of this application, the terms “computer readable medium” and “computer readable media” are entirely restricted to tangible, physical objects that store information in a form that is readable by a computer. These terms exclude any wireless signals, wired download signals, and any other ephemeral signals.

To provide for interaction with a user, implementations of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending items to and receiving items from a device that is used by the user; for example, by sending web pages to a web browser on a user's client device in response to requests received from the web browser.

Implementations of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some implementations, a server transmits data (e.g., an HTML page) to a client device (e.g., for purposes of displaying data to and receiving user input from a user interacting with the client device). Data generated at the client device (e.g., a result of the user interaction) can be received from the client device at the server.

It is understood that any specific order or hierarchy of steps in the processes disclosed is an illustration of example approaches. Based upon design preferences, it is understood that the specific order or hierarchy of steps in the processes may be rearranged, or that some illustrated steps may not be performed. Some of the steps may be performed simultaneously. For example, in certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language claims, where reference to an element in the singular is not intended to mean “one and only one” unless specifically so stated, but rather “one or more.” Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject disclosure.

A phrase such as an “aspect” does not imply that such aspect is essential to the subject technology or that such aspect applies to all configurations of the subject technology. A disclosure relating to an aspect may apply to all configurations, or one or more configurations. A phrase such as an aspect may refer to one or more aspects and vice versa. A phrase such as a “configuration” does not imply that such configuration is essential to the subject technology or that such configuration applies to all configurations of the subject technology. A disclosure relating to a configuration may apply to all configurations, or one or more configurations. A phrase such as a configuration may refer to one or more configurations and vice versa.

The word “exemplary” is used herein to mean “serving as an example or illustration.” Any aspect or design described herein as “exemplary” is not necessarily to be construed as preferred or advantageous over other aspects or designs.

1. A computer-implemented method comprising:
receiving, by one or more computing devices via an electronic network, a search request to provide a user with a collection of items;
identifying, by the one or more computing devices responsive to the search request, a list of a plurality of items for display to the user, each of the plurality of items having a score and being associated with media content, wherein the list of the plurality of items is sorted based on a distance-based ranking;
identifying, by the one or more computing devices, one or more variation features based on features of the plurality of items, the one or more variation features including a media content type;
diversifying, by the one or more computing devices, the list of the plurality of items while maintaining the distance-based ranking of the list by processing each of the items in order of the sorting, the processing for each item of the plurality of items comprising:
selecting the item as a candidate item;
determining, with respect to a plurality of time intervals associated with the plurality of items, a time interval that includes a time associated with the candidate item;
determining one or more demotion criteria with respect to the candidate item, wherein the one or more demotion criteria include whether the candidate item and another item of the plurality of items have a same feature value with regard to at least one of the one or more variation features;
calculating a threshold score with respect to the candidate item based on the score of the candidate item and a demotion factor based on the determined time interval associated with the candidate item;
identifying a set of items from the plurality of items that meets the demotion criteria with respect to the candidate item;
selecting a number of items from the set of items equal to an interval number value N and setting the score for all other items of the set of items to the threshold score; and
rearranging the list of the plurality of items according to the score of each of the plurality of items based on setting the scores of the other items; and
providing, in response to the search request, by the one or more computing devices via the electronic network, the rearranged list of the plurality of items to a device remote from the one or more computing devices for display in a web-based content feed to the user.

2. The method of claim 1, wherein the list is sorted according to distance-based criteria.

3. The method of claim 1, wherein the list is sorted according to the score for each of the plurality of items.

4. The method of claim 1, wherein the demotion criteria further includes whether an item has a score that satisfies a condition as compared to the score of the candidate item.

5. (canceled)

6. (canceled)

7. The method of claim 1, wherein the demotion criteria comprises whether the score of the item satisfies a condition as compared to the threshold score.

8. The method of claim 1, wherein the demotion factor is defined based on a distance-based location of the candidate item.

9. (canceled)

10. The method of claim 1, where the score for each of the plurality of items is calculated based on relevance and importance of the item and further based on a distance-based location assigned to the item, the distance-based location defining the location of the item with respect to one of the plurality of items or a current location at a time of the identification of the plurality of items.

11. The method of claim 10, wherein the distance-based ranking is based on a time-based unit of measurement, and wherein the time interval is a value having the same unit of measurement.

12. (canceled)

13. The method of claim 11, where the distance-based ranking is based on a geographic distance of a corresponding content item of the plurality of items relative to at least one other content item of the plurality of items.

14. The method of claim 1, further comprising:
determining the interval number value N associated with the at least one feature.

15. The method of claim 1, wherein the demotion factor is determined at least in part based on one or more of a number of other items of the set of items or a position of each item of the other items of the set of items within the list.

16. The method of claim 1, further comprising:
receiving the collection of items responsive to the search request;
defining a set of buckets, each bucket of the set of buckets representing a different range of distance-based criteria;
determining a value of the distance-based criteria for each item of the collection of items; and
placing each item of the collection of items within one of buckets of the set of buckets, wherein each item is placed in the bucket having a time range associated with a respective interval of the plurality of time intervals.

17. The method of claim 16, further comprising:
identifying a first set of features corresponding to each of the items of the collection of items;
determining, based on the identified first set of features, whether to move an item from its bucket to another bucket of the set of buckets; and
moving the item to another bucket when it is determined that the item should be moved.

18. The method of claim 16, wherein the list of the plurality of items comprises the items within at least a first bucket of the set of buckets.

19. A system comprising:
one or more processors; and
a machine-readable medium comprising instructions stored therein, which when executed by the processors, cause the processors to perform operations comprising:
receiving, via an electronic network, a search request to provide a user with a collection of items;
identifying, responsive to the search request, a list of a plurality of items for display to the user sorted based on a distance-based ranking according to one or more criteria, each of the plurality of items having a score and being associated with media content;
diversifying the list of the plurality of items according to one or more variation features while maintaining the distance-based ranking of the list, the one or more variation features including a media content type, the diversifying comprising processing the items of the list of the plurality of items, the processing comprising:
selecting a first unprocessed item of the plurality of items as a candidate item;
determining, with respect to a plurality of time intervals associated with the plurality of items, a time interval that includes a time associated with the candidate item;
determining a set of items from the plurality of items that meets one or more demotion criteria with respect to the candidate item, wherein the one or more demotion criteria include whether the candidate item and another item of the plurality of items have a same feature value with regard to at least one of the one or more variation features;
determining a demotion factor based on the determined time interval associated with the candidate item;
calculating a threshold score with respect to the candidate item based on the score of the candidate item and the demotion factor;
selecting a number of items from the set of items equal to an interval number value N and setting the score for all other items of the set of items to the threshold score; and
rearranging the list of the plurality of items according to the score of each of the plurality of items based on setting the scores of the other items; and
providing, in response to the search request, via the electronic network, the rearranged list of the plurality of items to a remote device for display in a web-based content feed to the user when all items of the plurality of items have been processed.

20. A non-transitory machine-readable medium comprising instructions stored therein, which when executed by a machine, cause the machine to perform operations comprising:
receiving, via an electronic network, a search request to provide a user with a collection of items;
identifying, by the one or more computing devices responsive to the search request, a list of a plurality of items for display to the user being sorted based on a distance-based ranking according to one or more criteria, each of the plurality of items having a score and being associated with media content;
identifying one or more variation features for diversifying the list based on features of the plurality of items, the one or more variation features including a media content type;
diversifying the list of the plurality of items while maintaining the distance-based ranking of the list, the diversifying comprising processing each item of the list of the plurality of items by:
selecting a first unprocessed item of the plurality of items as a candidate item;
determining, with respect to a plurality of time intervals associated with the plurality of items, a time interval that includes a time associated with the candidate item;
determining a set of items from the plurality of items that meets one or more demotion criteria with respect to the candidate item, wherein the one or more demotion criteria include whether the candidate item and another item have a same feature value with regard to at least one of the one or more variation features;
determining a demotion factor based on the determined time interval associated with the candidate item;
calculating a threshold score with respect to the candidate item based on the score of the candidate item and the demotion factor;
selecting a number of items from the set of items equal to an interval number value N and setting the score for all other items of the set of items to the threshold score; and
rearranging the list of the plurality of items according to the score of each of the plurality of items based on setting the scores of the other items; and
providing, in response to the search request, via the electronic network, the rearranged list of the plurality of items to a remote device for display in a web-based current feed to the user.

21. The method of claim 1, wherein the media content comprises a hyperlink, audio or video file, or image.

22. The system of claim 19, wherein the media content comprises a hyperlink, audio or video file, or image.

23. The non-transitory machine-readable medium of claim 20, wherein the media content comprises a hyperlink, audio or video file, or image.
